(19) United States
(12) Patent Application Publication
(10) Pub. No.: US 2025/0296211 A1
(43) Pub. Date: Sep. 25, 2025

(54) DISPLAY DEVICE, DISPLAY CONTROL METHOD, AND STORAGE MEDIUM

(71) Applicant: KABUSHIKI KAISHA TOSHIBA, Tokyo (JP)

(72) Inventors: Hiroki SHINAGAWA, Yokohama Kanagawa (JP); Sumire NISHIJIMA, Kodaira Tokyo (JP); Yukino MASUI, Yokohama Kanagawa (JP); Takanori YOSHII, Kawasaki Kanagawa (JP); Kyotaro HAYASHI, Yokohama Kanagawa (JP); Hiroaki NAKAMURA, Kawasaki Kanagawa (JP); Yoshiyuki HIRAHARA, Mishima Shizuoka (JP); Masamitsu FUKUDA, Yokohama Kanagawa (JP); Takafumi KOZAKAI, Ota Tokyo (JP); Yasuo NAMIOKA, Nerima Tokyo (JP)

(21) Appl. No.: 19/060,391

(22) Filed: Feb. 21, 2025

(30) Foreign Application Priority Data
Mar. 21, 2024 (JP) 2024-045143

(51) Int. Cl. B25B 23/142; B25B 23/15; G06F 3/01; G06F 3/03; H04N 13/344; H04N 13/383; H04N 13/398

(52) U.S. Cl. CPC B25B 23/1425; B25B 23/15; G06F 3/011; G06F 3/0312; H04N 13/344; H04N 13/383; H04N 13/398

(57) ABSTRACT

According to one embodiment, a display device is configured to display a virtual space to overlap a real space. The display device is configured to acquire a position of a fastening location of an article present in the real space, the position of the fastening location being preregistered. The display device is configured to acquire a position of the display device. The display device is configured to set a display position of a first virtual object at a prescribed position with respect to the fastening location when viewed from the display device, the first virtual object including information related to the fastening location. The display device is configured to repeat the acquisition of the position of the display device and the setting of the display position of the first virtual object.

### CROSS-REFERENCE TO RELATED APPLICATIONS

This application is based upon and claims the benefit of priority from Japanese Patent Application No. 2024-045143, filed on Mar. 21, 2024; the entire contents of which are incorporated herein by reference.

### FIELD

Embodiments of the invention generally relate to a display device, a display control method, and a storage medium.

### BACKGROUND

Conventionally, a display device that can display a virtual space to overlap real space has been used to increase the efficiency of a task. The display device can provide various information to a worker. The worker can perform the task more efficiently by referring to the displayed information. Technology that can further improve the convenience of the display device is desirable.

### BRIEF DESCRIPTION OF THE DRAWINGS

FIG. 1 is a schematic view illustrating a display device according to an embodiment;

FIG. 2 is a schematic view illustrating an article that is a task object;

FIG. 3 is a schematic view for describing a display example of the display device;

FIG. 4 is a schematic view for describing processing according to a first embodiment;

FIG. 5 is a schematic view showing a specific example of a virtual object;

FIG. 6 is a schematic view for describing the processing according to the first embodiment;

FIGS. 7A and 7B are schematic views for describing the processing according to the first embodiment;

FIG. 8 is a schematic view for describing the processing according to the first embodiment;

FIGS. 9A and 9B are schematic views showing display examples according to the display device according to the first embodiment;

FIG. 10 is a schematic view showing a display example according to a display device according to a reference example;

FIG. 11 is a schematic view for describing processing according to the first embodiment;

FIGS. 12A to 12C are schematic views showing display examples according to the display device according to the first embodiment;

FIG. 13 is a schematic view showing a display example according to the display device according to the first embodiment;

FIG. 14 is a schematic plan view for describing processing according to the first embodiment;

FIG. 15 is an example of surface information;

FIG. 16 is a schematic plan view for describing the processing according to the first embodiment;

FIG. 17 is a schematic plan view for describing processing according to the first embodiment;

FIG. 18 is a schematic plan view for describing the processing according to the first embodiment;

FIGS. 19A and 19B are schematic plan views for describing the processing according to the first embodiment;

FIGS. 20A and 20B are schematic plan views for describing the processing according to the first embodiment;

FIGS. 21A and 21B are schematic views for describing processing according to the first embodiment;

FIG. 22 is a schematic view showing a task;

FIG. 23 is a schematic view for describing calculation methods according to the first embodiment;

FIGS. 24A and 24B are schematic views for describing the calculation methods according to the first embodiment;

FIG. 25 is a schematic view for describing the calculation methods according to the first embodiment;

FIG. 26 is a schematic view for describing the calculation methods according to the first embodiment;

FIGS. 27A and 27B are schematic views showing display examples according to the display device according to the first embodiment;

FIGS. 28A and 28B are schematic views showing display examples according to the display device according to the first embodiment;

FIGS. 29A and 29B are schematic views showing display examples according to the display device according to the first embodiment;

FIG. 30 is a flowchart showing a processing method according to the embodiment;

FIG. 31 is a schematic view illustrating a task;

FIGS. 32A and 32B are schematic views showing display examples according to the display device according to a modification of the first embodiment;

FIGS. 33A and 33B are schematic views for describing processing according to the modification of the first embodiment;

FIGS. 34A and 34B are schematic views for describing the processing according to the modification of the first embodiment;

FIG. 35 is a schematic view for describing the processing according to the modification of the first embodiment;

FIGS. 36A and 36B are schematic views showing display examples according to the display device according to a second embodiment;

FIGS. 37A and 37B are schematic views showing display examples according to the display device according to the second embodiment;

FIG. 38 is a schematic view showing a display example according to the display device according to the second embodiment; and

FIG. 39 is a schematic view showing a hardware configuration.

### DETAILED DESCRIPTION

According to one embodiment, a display device is configured to display a virtual space to overlap a real space. The display device is configured to acquire a position of a fastening location of an article present in the real space, the position of the fastening location being preregistered. The display device is configured to acquire a position of the display device. The display device is configured to set a display position of a first virtual object at a prescribed position with respect to the fastening location when viewed from the display device, the first virtual object including information related to the fastening location. The display device is configured to repeat the acquisition of the position of the display device and the setting of the display position of the first virtual object.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

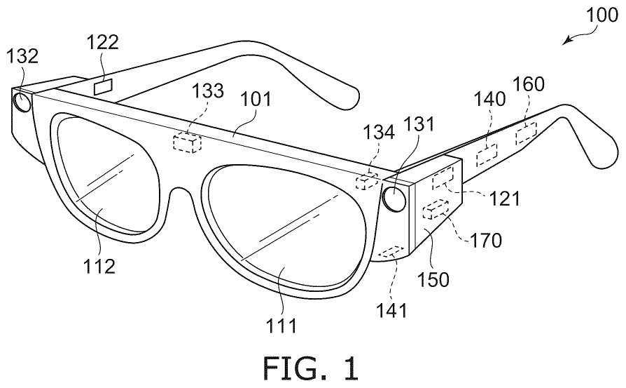

FIG. 1 is a schematic view illustrating a display device according to an embodiment.

The embodiment of the invention relates to a display device. For example, as shown in FIG. 1, the display device 100 according to the embodiment includes a frame 101, a lens 111, a lens 112, a projection device 121, a projection device 122, an image camera 131, a depth camera 132, a light source 133, an eye tracking camera 134, a sensor 140, a microphone 141, a processing device 150, a battery 160, and a storage device 170.

In the illustrated example, the display device 100 is a binocular head mounted display. Two lenses, i.e., the lens 111 and the lens 112, are fit into the frame 101. The projection device 121 and the projection device 122 respectively project information onto the lenses 111 and 112.

The projection device 121 and the projection device 122 display a recognition result of a body of a worker (a wearer), a virtual object, etc., on the lenses 111 and 112. Only one of the projection device 121 or the projection device 122 may be included; and information may be displayed on only one of the lens 111 or the lens 112.

The lens 111 and the lens 112 are light-transmissive. The worker can visually recognize reality via the lenses 111 and 112. Also, the worker can visually recognize the information projected onto the lenses 111 and 112 by the projection devices 121 and 122. Information (virtual space) is displayed to overlap real 15 space by being projected by the projection devices 121 and 122. The image camera 131 detects visible light and obtains a two-dimensional image. The depth camera 132 irradiates infrared light and obtains a depth image based on the reflected infrared light. The light source 133 irradiates light (e.g., infrared 20 light) toward an eyeball of the wearer. The eye tracking camera 134 detects light reflected by the eyeball of the wearer. The sensor 140 is a six-axis detection sensor and is configured to detect angular velocities in three axes and accelerations in three axes. The microphone 141 accepts an audio input.

The processing device 150 controls components of the display device 100. For example, the processing device 150 controls the projection devices 121 and 122 and causes the projection devices 121 and 122 to display information on the lenses 111 and 112. Hereinafter, the processing device 150 using the projection devices 121 and 122 to display information on the lenses 111 and 112 also is called simply “the processing device displaying information”. The processing device 150 also detects movement of the visual field based on a detection result of the sensor 140. The processing device 150 modifies the display by the projection devices 121 and 122 according to the movement of the visual field.

The processing device 150 also is configured to perform various processing by using data obtained from the image camera 131 and the depth camera 132, data of the storage device 170, etc. For example, the processing device 150 recognizes a preset object based on the image obtained by the image camera 131. The processing device 150 recognizes the surface shape of the object based on the image obtained by the depth camera 132. The processing device 150 calculates the viewpoint and line of sight of the eyes of the worker based on the detection result obtained by the eye tracking camera 134.

The battery 160 supplies power necessary for the operations to the components of the display device 100. The storage device 170 stores data necessary for the processing of the processing device 150, data obtained by the processing of the processing device 150, etc. The storage device 170 may be located outside the display device 100, and may communicate with the processing device 150.

The display device is not limited to the illustrated example, and may be a monocular head mounted display. The display device may be an eyeglasses-type as illustrated, or may be a helmet-type.

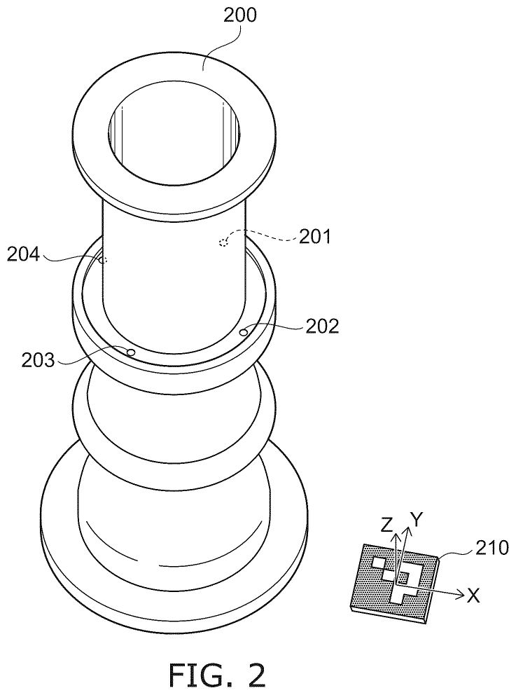

FIG. 2 is a schematic view illustrating an article that is a task object.

For example, a task is performed on the article 200 shown in FIG. 2. The article 200 is a hollow tubular member, and includes fastening locations 201 to 204. In the task, a tool is used to fasten a fastener such as a screw or the like to the article. Or, a tool is used to loosen a screw fastened to the article. The article is a part, a unit, a semifinished product, etc., for making a product. The tool is a wrench, a screw driver, etc. Herein, an example is mainly described in which embodiments of the invention are applied to a fastening task of tightening a screw.

The worker uses an extension bar and a wrench to turn screws at the fastening locations 201 to 204. A marker 210 is located proximate to the task object. In the illustrated example, the marker 210 is an AR marker. As described below, the marker 210 is provided for setting the origin of the three-dimensional coordinate system. Instead of the AR marker, a one-dimensional code (a barcode), a two-dimensional code (a QR code (registered trademark)), etc., may be used as the marker 210. Or, instead of a marker, the origin may be indicated by a hand gesture. The processing device 150 sets the three-dimensional coordinate system by using multiple points indicated by the hand gesture as a reference. For example, the three-dimensional coordinate system is represented by an X-axis direction (a first axial direction), a Y-axis direction (a second axial direction), and a Z-axis direction which are orthogonal to each other.

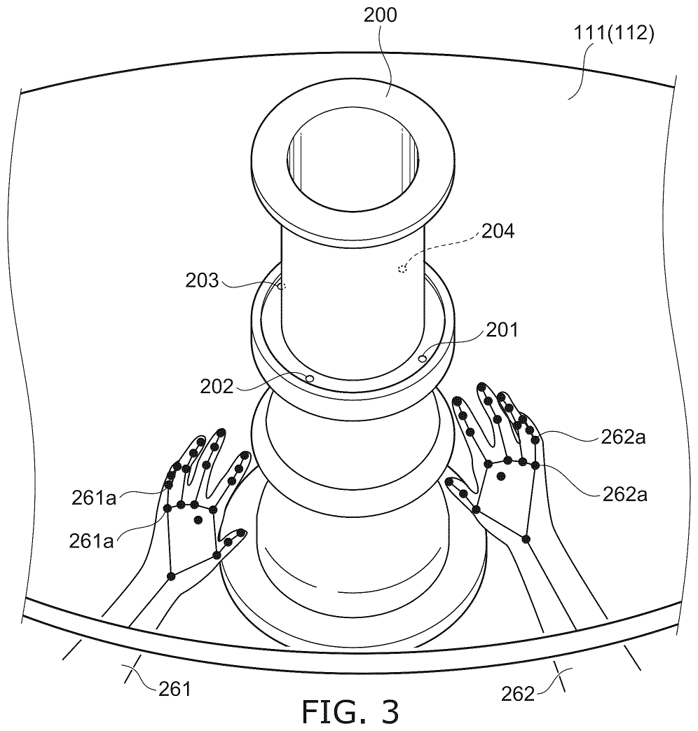

FIG. 3 is a schematic view for describing a display example of the display device.

When the fastening task is started, the image camera 131 and the depth camera 132 image the marker 210. The processing device 150 recognizes the marker 210 based on the captured image. The processing device 150 sets the three-dimensional coordinate system by using the position of the marker 210 as a reference.

The object for the setting is arbitrary as long as the three-dimensional coordinate system can be set. Herein, an example is described in which the three-dimensional coordinate system is set using the marker 210. When starting the task, the image camera 131 and the depth camera 132 image the marker 210. The processing device 150 recognizes the marker 210 based on the captured image. The processing device 150 sets the origin of the virtual space by using the position and orientation of the marker 210 as a reference. The three-dimensional coordinate system is defined based on the origin. By setting the origin referenced to an object present in real space, a virtual object can be displayed to correspond to the object in real space.

The image camera 131 and the depth camera 132 image the article 200, the left hand of the worker, and the right hand of the worker. The processing device 150 recognizes the left hand and the right hand based on the captured image. When a left hand 261 and a right hand 262 are recognized, the processing device 150 measures the positions of the hands. Specifically, each hand includes multiple joints such as a DIP joint, a PIP joint, an MP joint, a CM joint, etc. The position of any of these joints is used as the position of the hand. The centroid position of multiple joints may be used as the position of the hand. Or, the center position of the entire hand may be used as the position of the hand. The processing device 150 performs hand tracking in which the positions of the hands are repeatedly measured.

The processing device 150 causes the projection devices 121 and 122 to display the recognition result on the lenses 111 and 112. Hereinafter, the processing device using the projection device to display information on the lens also is called simply “the processing device displaying information”.

For example, as shown in FIG. 3, the processing device 150 displays the recognition result of the left hand 261 and the recognition result of the right hand 262 to overlap the hands in real space. In the illustrated example, multiple virtual objects 261a and multiple virtual objects 262a are displayed as the recognition results of the left and right hands 261 and 262. The multiple virtual objects 261a respectively indicate multiple joints of the left hand 261. The multiple virtual objects 262a respectively indicate multiple joints of the right hand 262. Virtual objects that respectively indicate the surface shape of the left hand 261 and the surface shape of the right hand 262 may be displayed instead of the joints.

### First Embodiment

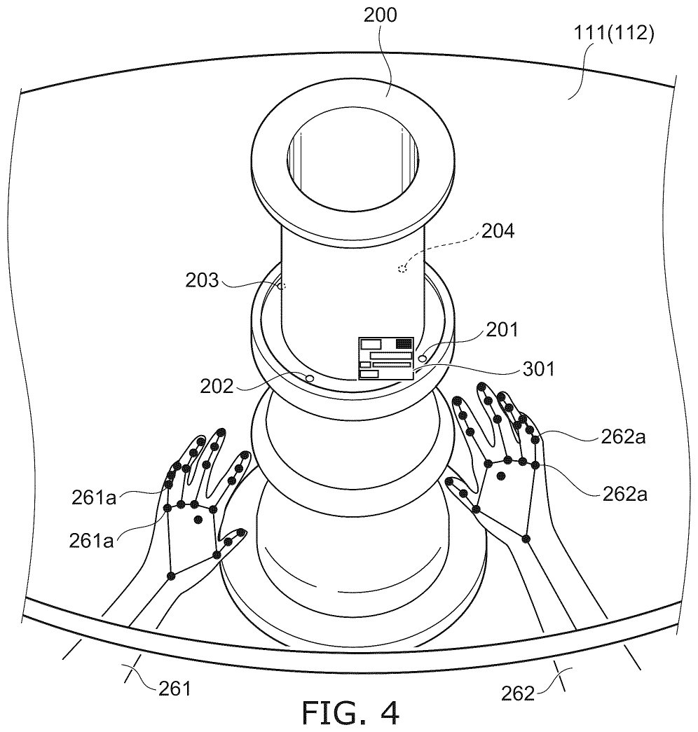

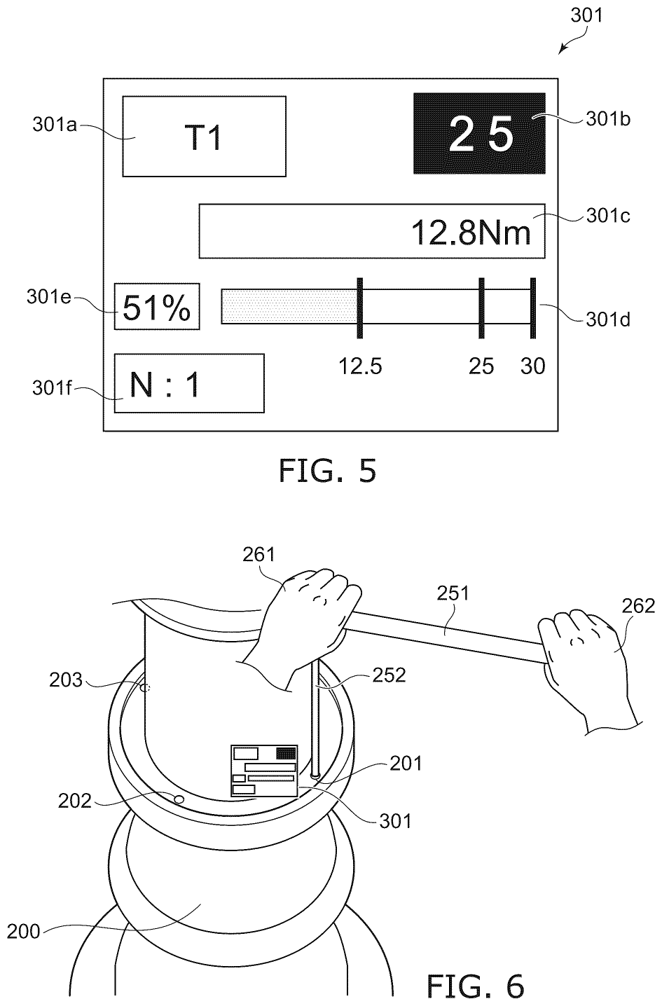

FIGS. 4, 6, 7A, 7B, and 8 are schematic views for describing processing according to the first embodiment. FIG. 5 is a schematic view showing a specific example of virtual objects. When the three-dimensional coordinate system is set, the processing device 150 displays virtual objects as shown in FIG. 4. In the illustrated example, a virtual object 301 (a first virtual object) is displayed proximate to the fastening location 201. For example, the distance between the fastening location 201 and the virtual object 301 is less than the distances between the virtual object 301 and the other fastening locations 202 to 204. The virtual object 301 includes information related to a task. The information is illustrated using characters (a logogram, a phonogram, an ideogram, etc.). The worker can ascertain information necessary for the task from the virtual object 301.

For example, as shown in FIG. 5, the virtual object 301 includes task information such as identification information 301a, a specified torque value 301b, a detected value 301c, a meter 301d, a percentage 301e, and a count 301f. The identification information 301a is unique identification information assigned to the fastening location 201, and is represented by a character string. The specified torque value 301b is the torque value necessary for the screw-tightening at the fastening location 201, and is prespecified.

In the task, a tool that can detect a torque value may be used. In such a case, the detected value 301c indicates the torque value detected by the tool. The meter 301d shows the specified torque value and the detected torque value. The percentage 301e shows the ratio of the detected value to the specified torque value. In some tasks, a screw must be tightened multiple times at one fastening location. In such a case, the count 301f indicates the number of times that the screw is to be tightened at the fastening location 201. The worker performs the task while confirming the content displayed in the virtual object 301.

The processing device 150 also calculates the position of the display device 100. As an example, the processing device 150 uses a spatial mapping function to calculate the position and direction of the display device 100. More specifically, the depth camera 132 measures distances to objects in the surrounding area of the display device 100. Surface information of the objects in the surrounding area is obtained from the measurement result (the depth image) of the depth camera 132. The surface information includes the positions and directions of the surfaces of the objects. For example, the surface of each object is represented by multiple meshes; and the position and direction of each mesh are calculated. Based on the surface information, the processing device 150 calculates the relative position and direction of the display device 100 with respect to the surfaces of the objects in the surrounding area. When the marker 210 is recognized, the positions of the surfaces also are represented using the three-dimensional coordinate system having the marker 210 as the origin. The position and direction of the display device 100 in the three-dimensional coordinate system are calculated based on the positional relationship between the display device 100 and the surfaces of the objects.

The spatial mapping is repeatedly performed at a prescribed interval. The surface information of the objects in the surrounding area is obtained each time the spatial mapping is performed. The processing device 150 calculates the changes of the positions and directions of the surfaces between the result of the latest spatial mapping and the result of the directly-previous spatial mapping. In circumstances in which the objects in the surrounding area do not move, changes of the positions of the surfaces and changes of the directions of the surfaces correspond to a change of the position of the display device 100 and a change of the direction of the display device 100. The processing device 150 calculates the change amounts of the position and direction of the display device 100 based on the changes of the positions of the surfaces and the changes of the directions of the surfaces. The detection result of the sensor 140 also may be used to calculate the change amounts of the position and direction of the display device 100. The processing device 150 updates the position and direction of the display device 100 based on the obtained change amount. Instead of spatial mapping, existing positioning methods may be used to acquire the position of the display device 100.

The processing device 150 may use the result of the spatial mapping and the detection result obtained by the eye tracking camera 134 to calculate the position of the viewpoint of the worker in the three-dimensional coordinate system. In such a case, the processing device 150 may use the position of the viewpoint as the position of the display device 100.

When the position of the display device 100 is acquired by one of the methods, the processing device 150 displays the virtual object 301 so that the virtual object 301 is positioned at the side of the fastening location 201 when viewed from the display device 100 as shown in FIG. 4. As shown in FIG. 6, the worker uses a wrench 251 and an extension bar 252 to turn the screw at the fastening location 201. At this time, the worker performs the task while referring to the virtual object 301.

A method for calculating the display position of the virtual object 301 will now be described. First, the processing device 150 acquires the position of the display device 100 and the position of the fastening location 201. The position of the fastening location 201 in the three-dimensional coordinate system having the marker 210 as an origin is preregistered in a database. The position of the display device 100 is obtained by the spatial mapping described above, etc. As described above, the position of the viewpoint of the wearer may be used as the position of the display device 100.

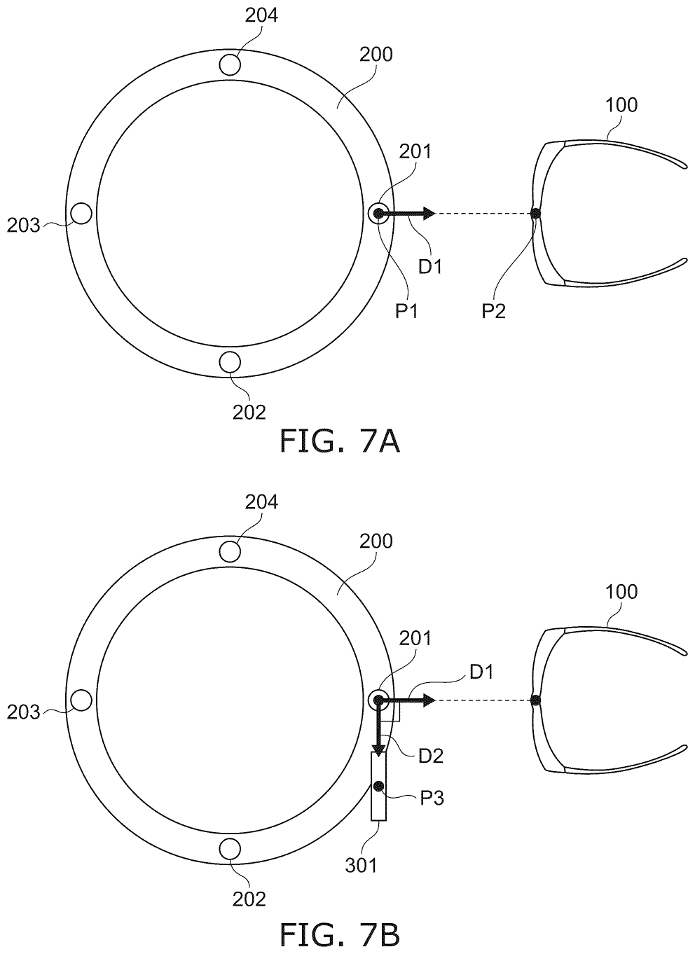

As shown in FIG. 7A, the processing device 150 calculates a direction D1 from a position P1 of the fastening location 201 toward a position P2 of the display device 100. As shown in FIG. 7B, the processing device 150 calculates a direction D2 that crosses the direction D1. The tilt of the direction D2 with respect to the horizontal plane is less than the tilt of the direction D2 with respect to the vertical direction. The tilt of the direction D2 with respect to the horizontal plane is set within the range of not less than 0 degrees and not more than 30 degrees. The tilt of the direction D2 with respect to the direction D1 is set within the range of not less than 60 degrees and not more than 90 degrees. For example, the direction D2 is set to be perpendicular to the direction D1 and parallel to the horizontal plane.

The processing device 150 calculates a position P3 separated a prescribed distance from the position P1 in the direction D2. The distance is preregistered before the task. The distance is set according to the length of the tool used, the spacing between the fastening locations, etc. For example, as the distance between the position P1 and the position P3 is increased, the virtual object 301 is less likely to overlap the fastening location 201, but it becomes more difficult for the worker to ascertain the correspondence between the fastening location 201 and the virtual object 301. Accordingly, when the spacing between the fastening locations is short, the distance is set to be relatively short so that the worker easily ascertains the correspondence between the fastening location and the virtual object. When the spacing between the fastening locations is long, the distance is set to be relatively long so that the virtual object does not easily overlap the fastening location. As an example, the distance between the position P1 and the position P3 as set to be greater than 0.1 times and less than 0.5 times the distance between the fastening location 201 and the fastening location 202 (or the fastening location 204) most proximate to the fastening location 201.

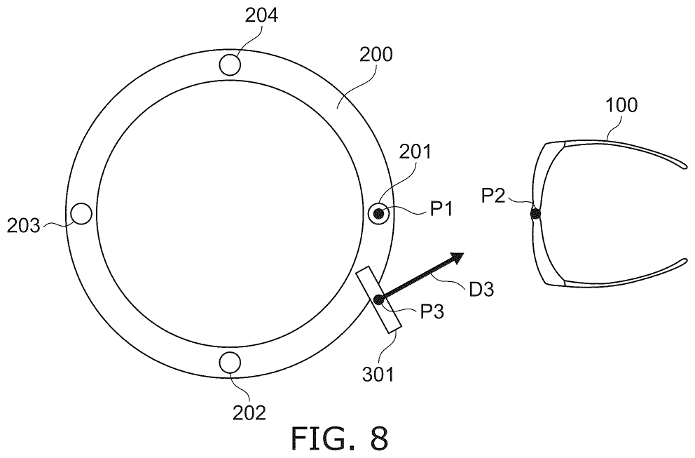

The processing device 150 sets the calculated position P3 as the display position of the virtual object 301. After setting the display position, the processing device 150 sets the display direction of the virtual object 301. The virtual object 301 includes characters. Accordingly, the appearance of the characters changes according to the display direction of the virtual object 301. It is favorable to set the display direction of the virtual object 301 so that the information is easily-viewable by the worker. For example, the display direction of the virtual object 301 is set to be parallel to the direction D1. Or, as shown in FIG. 8, a direction D3 from the position P3 toward the position P2 may be set as the display direction of the virtual object 301. The processing device 150 repeatedly performs the calculation of the display position of the virtual object 301. As a result, even when the display device 100 moves, the display position and display direction of the virtual object 301 are updated according to the position of the display device 100 after the movement.

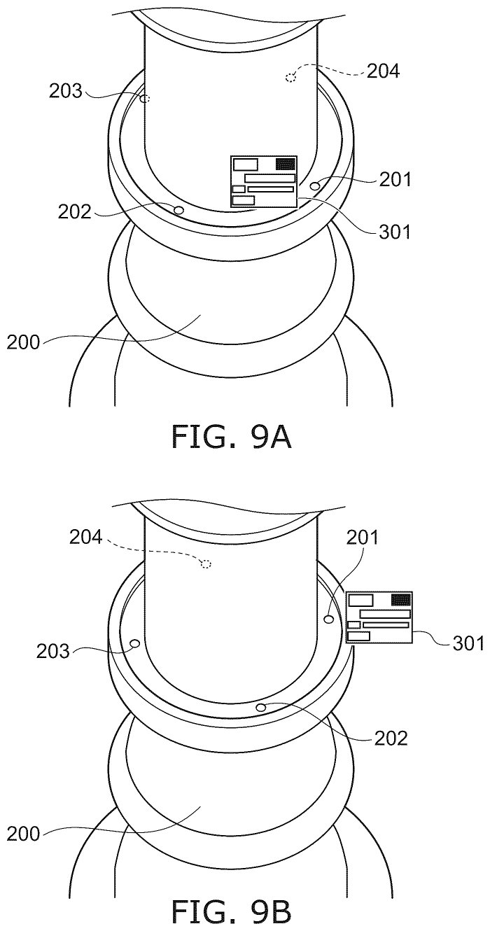

FIGS. 9A and 9B are schematic views showing display examples according to the display device according to the first embodiment.

For example, the worker moves in the leftward direction from the state shown in FIG. 9A. The processing device 150 acquires the position of the display device 100 after the movement and calculates the display position and display direction of the virtual object 301. As a result, as shown in FIG. 9B, the virtual object 301 is displayed at the side of the fastening location 201 when viewed from the display device 100 after the movement.

Advantages of the first embodiment will now be described. The display device can provide various information to the worker by displaying the virtual object. For example, as shown in FIG. 5, the virtual object provides information such as the specified torque value necessary for the screw-tightening, the torque value detected by the tool, the screw-tightening count at the fastening location, etc. It is favorable to display the virtual object at the vicinity of the fastening location. Because the virtual object is displayed at the vicinity of the fastening location, the worker can refer to the information of the virtual object while performing the task. Therefore, the efficiency of the task can be increased. Because the virtual object is displayed at the vicinity of the fastening location, the worker intuitively and easily ascertains which of the fastening locations has the information shown by the virtual object.

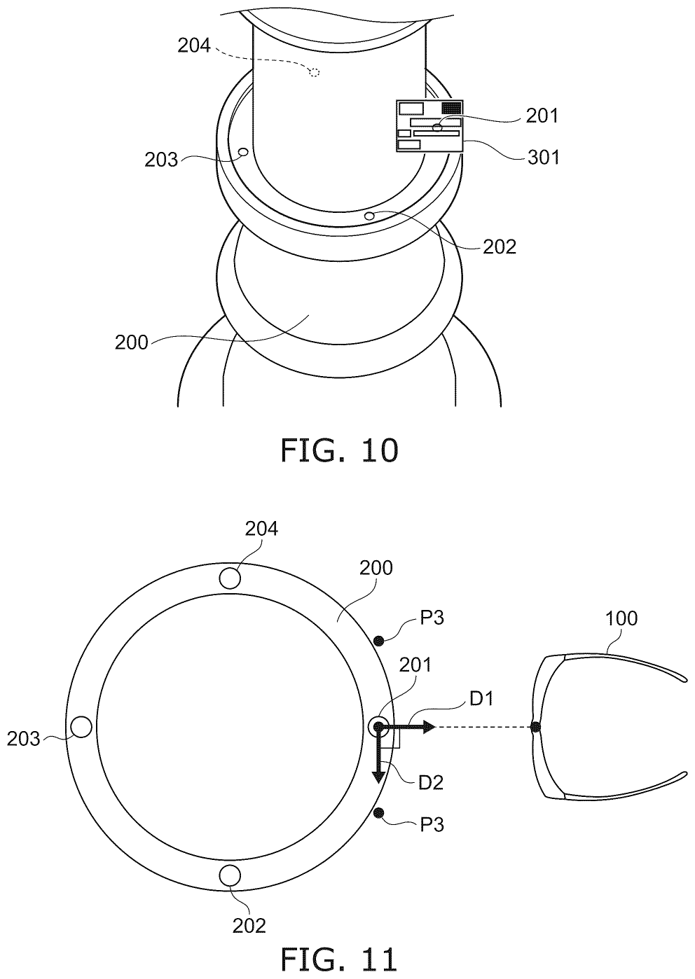

FIG. 10 is a schematic view showing a display example according to a display device according to a reference example. There is also a method in which the display position of the virtual object 301 when displaying the virtual object 301 is preregistered. In such a case, the positional relationship between the display device 100, the fastening location 201, and the virtual object 301 may cause the virtual object 301 to be displayed to overlap the fastening location 201. For example, the worker moves in the leftward direction from the state shown in FIG. 9A. When the display position of the virtual object 301 is fixed, the virtual object 301 is displayed to overlap the fastening location 201 as shown in FIG. 10. As a result, it is difficult for the worker to visually recognize the fastening location 201. The display of the virtual object 301 may obstruct the task.

For this problem, according to the first embodiment, the processing device 150 sets the display position of the virtual object at the side of the fastening location when viewed from the display device 100. Then, the processing device 150 repeatedly performs the acquisition of the position of the display device 100 and the setting of the display position of the virtual object 301. As a result, even when the display device 100 moves, the virtual object 301 is displayed at the prescribed position with respect to the fastening location 201 when viewed by the worker. Even when the worker moves, the time that the virtual object 301 overlaps the fastening location 201 can be reduced.

Favorably, the acquisition of the position of the display device 100 and the setting of the display position of the virtual object 301 are repeated at a sufficiently short interval. As a result, even when the display device 100 moves, the virtual object 301 can be prevented from overlapping the fastening location 201.

According to the first embodiment, the overlap between the virtual object and the fastening location can be suppressed, and the convenience of the display device can be improved. By using the display device according to the first embodiment, the efficiency of the task can be increased.

When an extension bar or a screw driver is used, the tool does not easily overlap the virtual object 301 because the virtual object 301 is displayed at the side. The virtual object 301 can be prevented from overlapping the tool and making it difficult for the worker to view the tool.

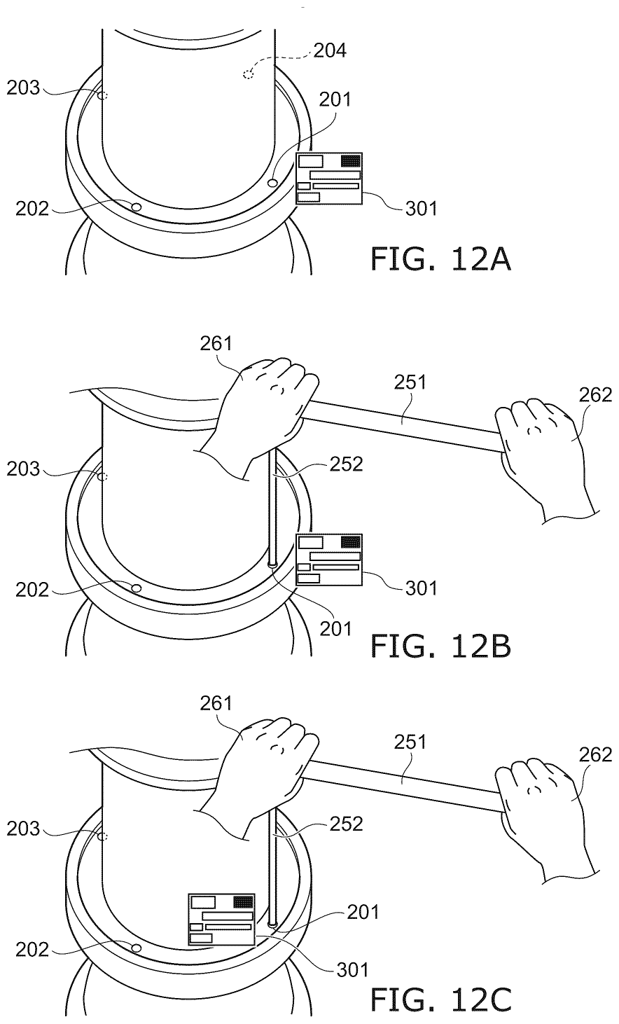

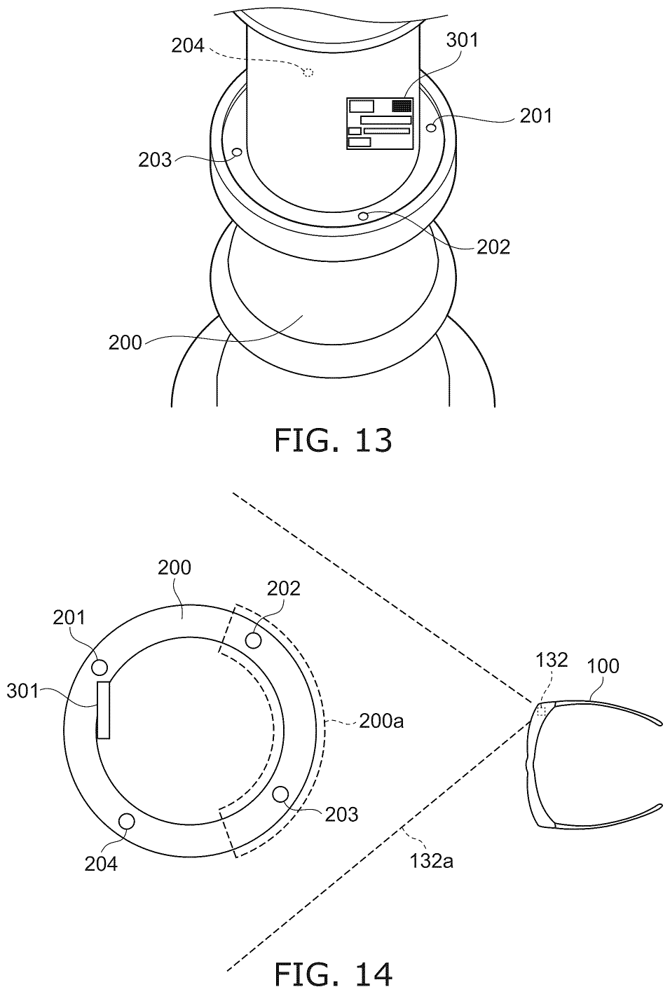

FIG. 11 is a schematic view for describing processing according to the first embodiment. FIGS. 12A to 12C and FIG. 13 are schematic views showing display examples according to the display device according to the first embodiment.

When the display position of the virtual object 301 is calculated, the position P3 may exist at both the left and right sides of the position P1 as shown in FIG. 11. At this time, the processing device 150 selects one position P3 of the two positions P3 and displays the virtual object at the selected position P3. The position P3 may be randomly selected.

Favorably, the processing device 150 selects one position P3 according to the positions of the recognized hands. With respect to the position P1, the processing device 150 selects the position P3 at the side opposite to the side at which the hands are present. As a result, the virtual object 301 is not easily concealed by the tool or the hands. The worker can visually recognize the virtual object 301 more easily.

As an example as shown in FIG. 12A, the virtual object 301 is displayed at the right side of the fastening location 201. In this state, the worker places a screw at the fastening location 201 and uses the wrench 251 and the extension bar 252 to turn the screw as shown in FIG. 12B. At this time, the processing device 150 recognizes the left and right hands 261 and 262. The left hand 261 is positioned substantially directly above the fastening location 201. The right hand 262 is positioned at the right side of the fastening location 201. As shown in FIG. 12C, based on these positional relationships, the processing device 150 displays the virtual object 301 at the left side of the fastening location 201, i.e., at the opposite side at which the right hand 262 is positioned.

The processing device 150 may determine whether or not the virtual object 301 overlaps an object in real space. For example, in the state shown in FIG. 9B, the fastening location 201 is positioned at the back side of the article when viewed from the display device 100. In such a case, the virtual object 301 may be displayed at the right side of the fastening location 201 as shown in FIG. 9B, or may be displayed at the left side of the fastening location 201 as shown in FIG. 13. The processing device 150 determines whether or not objects in real space overlap the virtual object 301 at the display positions shown in FIGS. 9B and 13.

In the illustrated example, the article 200 overlaps the virtual object 301 at the display position shown in FIG. 13. The article 200 does not overlap the virtual object 301 at the display position shown in FIG. 9B. Based on these determination results, the processing device 150 sets the display position of the virtual object 301 to the right side of the fastening location 201 as shown in FIG. 9B.

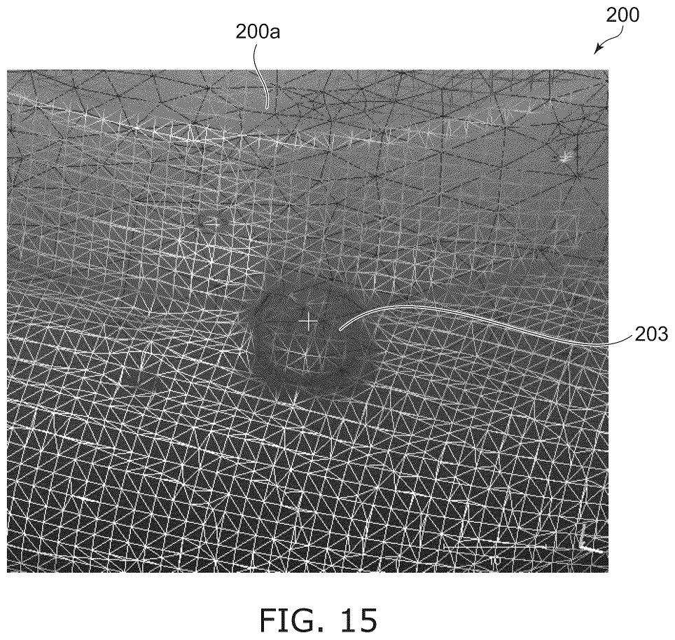

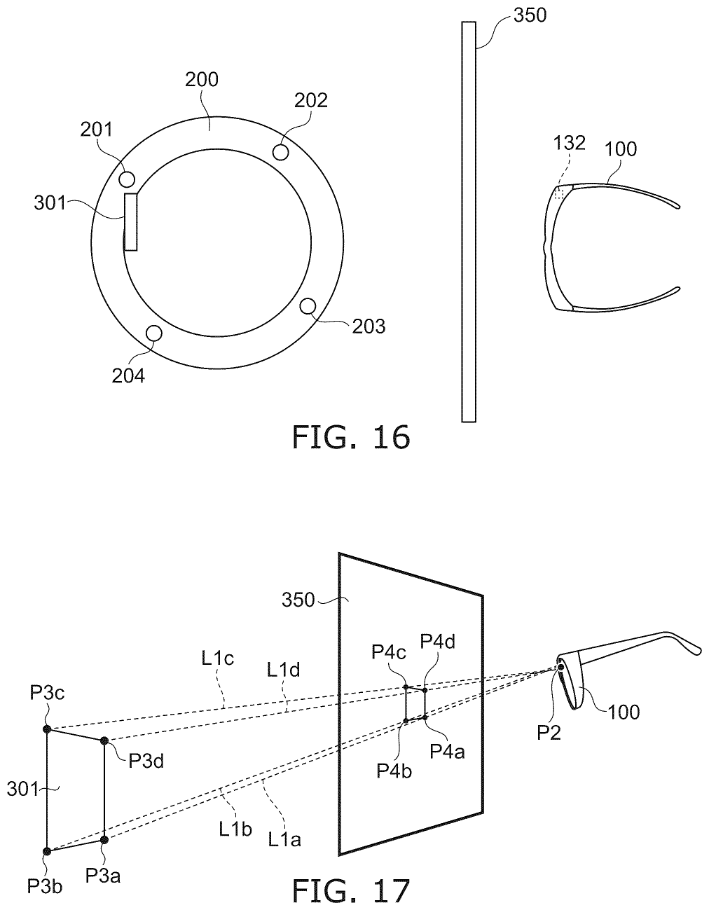

FIGS. 14 and 16 are schematic plan views for describing processing according to the first embodiment. FIG. 15 is an example of the surface information. FIGS. 17, 18, 19A, 19B, 20A, and 20B are schematic plan views for describing the processing according to the first embodiment.

An example of a method for determining the overlap between a real object and a virtual object will now be described.

As shown in FIG. 14, the depth camera 132 acquires surface information within a visual field 132a. More specifically, a region 200a of the article 200 positioned at the depth camera 132 side is visible from the depth camera 132. The distances between the depth camera 132 and the parts of the region 200a are measured. The surface information that indicates the positions and directions of the surfaces of the region 200a is obtained based on the measurement result.

FIG. 15 is surface information of the article 200 at the vicinity of the fastening location 203. The processing device 150 acquires mesh data representing the surfaces of the objects based on the measurement result of the depth camera 132. The mesh data is generated by subdividing the imaged area into multiple micro sections (meshes) and by assigning values (a position and a direction) to each mesh. Other than the region 200a, surface information such as the platform on which the article 200 is placed, a wall depthward of the article 200, etc., also may be acquired.

Based on the surface information obtained, the processing device 150 determines whether or not a real object is present in front of the virtual object 301. In the example shown in FIG. 14, the distance between the display device 100 and the region 200a is less than the distance between the display device 100 and the virtual object 301. It is therefore determined that a real object is present in front of the virtual object 301.

When a real object is determined to be present in front of the virtual object 301, the processing device 150 determines whether or not the virtual object 301 and the object overlap. As shown in FIG. 16, the processing device 150 sets a virtual surface 350. The virtual surface 350 is set in front of the article 200 and the virtual object 301. In other words, the virtual surface 350 is positioned between the display device 100 and the article 200 and between the display device 100 and the virtual object 301.

The processing device 150 projects, onto the virtual surface 350, the virtual object 301 that is displayed at the position P3. Specifically, as shown in FIG. 17, the processing device 150 acquires positions P3a to P3d of multiple points on the outer edge of the virtual object 301. The number of positions that are acquired are modifiable as appropriate according to the shape, size, etc., of the virtual object. The processing device 150 calculates line segments L1a to L1d that connect the position P2 of the display device 100 respectively to the positions P3a to P3d. The processing device 150 calculates positions P4a to P4d of the intersections between the virtual surface 350 and the line segments L1a to L1d. The region that is surrounded with the positions P4a to P4d is the virtual object 301 projected onto the virtual surface 350. Also, the processing device 150 uses a method similar to project the region 200a onto the virtual surface 350.

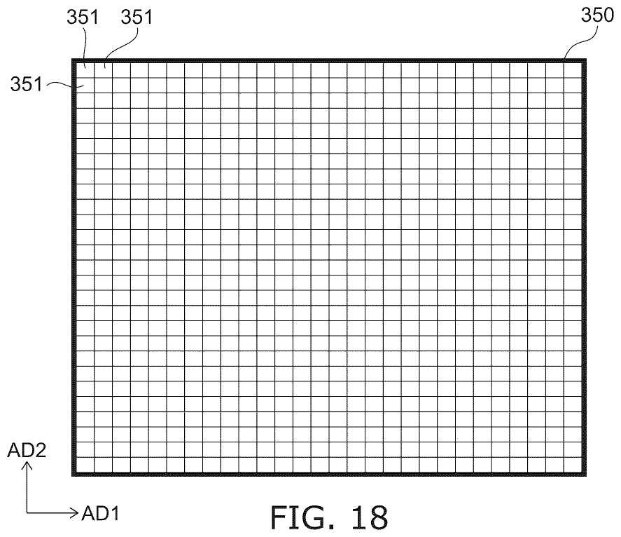

As shown in FIG. 18, multiple regions 351 are set in the virtual surface 350. The multiple regions 351 are arranged along a first arrangement direction AD1 and a second arrangement direction AD2. The first arrangement direction AD1 crosses the vertical direction and the direction of the display device 100. The second arrangement direction AD2 crosses the first arrangement direction AD1 and the direction of the display device 100. For example, the first arrangement direction AD1 is parallel to the horizontal plane and perpendicular to the direction of the display device 100. The second arrangement direction AD2 is perpendicular to the direction of the display device 100 and the first arrangement direction AD1.

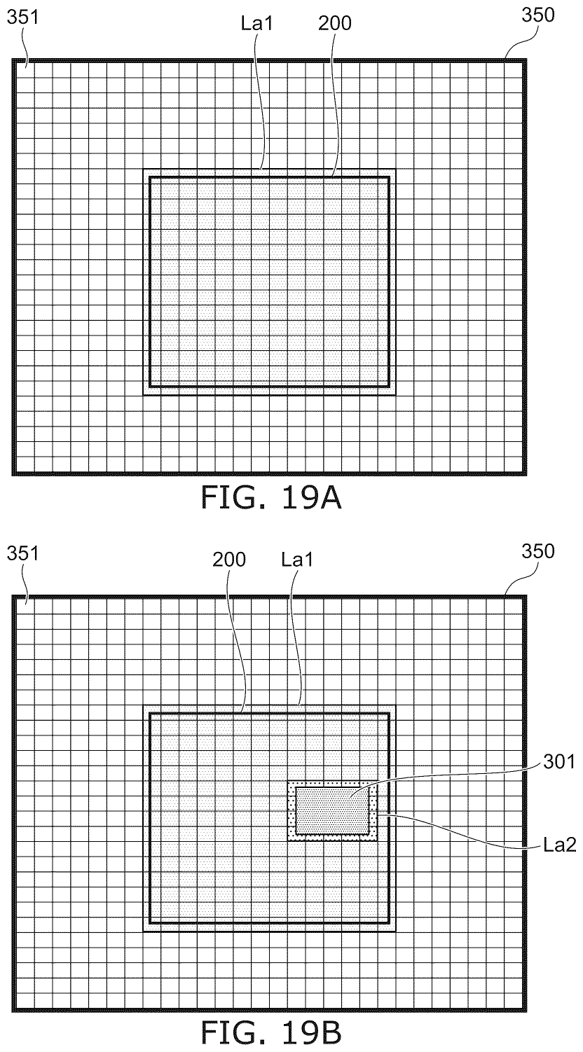

As shown in FIG. 19A, the processing device 150 designates regions 351 among the multiple regions 351 that overlap the article 200. The processing device 150 assigns a label La1 to the regions 351 overlapping the article 200. As shown in FIG. 19B, the processing device 150 designates regions 351 among the multiple regions 351 that overlap the virtual object 301. The processing device 150 assigns a label La2 to the regions 351 overlapping the virtual object 301.

At this time, the processing device 150 determines whether or not the regions 351 to which the label La1 is assigned and the regions 351 to which the label La2 is assigned overlap each other. The presence of a region 351 to which both the labels La1 and La2 are assigned means that the article 200 overlaps the virtual object 301 when viewed from the display device 100.

The processing device 150 determines whether or not the article 200 overlaps the virtual object 301 for each of the display position at the right side of the fastening location 201 and the display position at the left side of the fastening location 201. In the example shown in FIG. 14, the article 200 is determined to overlap the virtual object 301 when the virtual object 301 is positioned at the left side of the fastening location 201 when viewed from the display device 100. The article 200 is determined not to overlap the virtual object 301 when the virtual object 301 is positioned at the right side of the fastening location 201 when viewed from the display device 100. As a result, the display position of the virtual object 301 is set to the right side of the fastening location 201.

When the article 200 overlaps the virtual object 301 at both the right side and left side of the fastening location 201, the processing device 150 selects the position having the lesser overlap amount. The overlap amount is represented by the number of the regions 351 to which both the label La1 of the article 200 and the label La2 of the virtual object 301 are assigned.

When the real object overlaps the display position of the virtual object, the virtual object is displayed to overlap the real object as shown in FIG. 13 even when the real object is present in front of the virtual object. In such a case, it is difficult for the worker to ascertain the positional relationship between the virtual object and the real object. By setting the display position of the virtual object to reduce the overlap amount between the real object and the virtual object, the worker can more easily ascertain the positional relationship between the virtual object and the real object. The convenience of the display device 100 can be further improved.

When it is determined that there is an overlap between the real object and the virtual object, the processing device 150 may generate a straight line connecting the display device 100 and the virtual object and calculate distances between the straight line and the meshes. The processing device 150 extracts the meshes among all of the meshes for which the distance is less than a preset threshold. In the extraction, for example, meshes of other objects positioned behind the article 200 and meshes of objects (walls, etc.) laterally distant to the straight line are excluded. As a result, only meshes that may overlap the virtual object are extracted. The processing device 150 uses the extracted meshes to determine the overlap. By extracting the meshes, the calculation amount necessary to determine the overlap can be reduced.

There are cases where it is unfavorable for the virtual object to overlap the article, regardless of whether or not the virtual object is positioned in front of the article or beyond the article. For example, when the task is performed while confirming various locations of the article, it is difficult for the worker to view the article when the virtual object overlaps the article. In such a case, the processing device 150 searches for a position at which the virtual object 301 does not overlap the article 200. For example, the display position of the virtual object 301 is set to a position at the side of the fastening location 201 that is separated from the fastening location 201 by a prescribed distance. When the virtual object 301 at the set display position overlaps the article 200, the processing device 150 increases the distance between the fastening location 201 and the virtual object 301. The processing device 150 determines whether or not the virtual object 301 overlaps the article 200 at a display position more distant to the fastening location 201. The processing device 150 repeats the modification of the distance and the determination of the overlap to search for a position at which the virtual object 301 does not overlap the article 200.

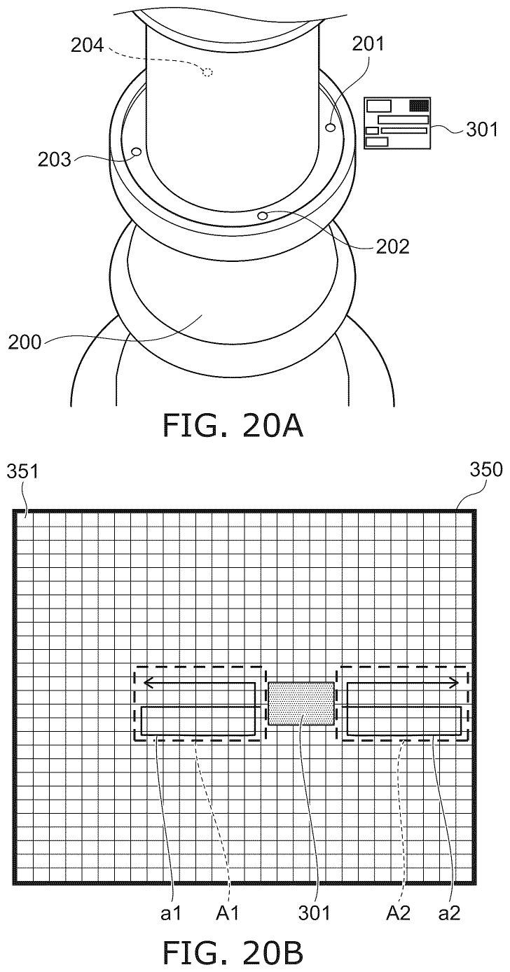

As an example, the virtual object 301 at the display position of the virtual object 301 shown in FIG. 9B overlaps the article 200. Similarly to the method described above, the overlap between the article 200 and the virtual object 301 is determined by projecting the article 200 and the virtual object 301 onto the virtual surface 350. When the virtual object 301 is determined to overlap the article 200, the processing device 150 moves the display position of the virtual object 301 away from the fastening location 201. As a result, as shown in FIG. 20A, the display position of the virtual object 301 is moved further rightward. The virtual object 301 that is displayed does not overlap the article 200 when viewed from the display device 100.

More specifically, when the virtual object 301 overlaps the article 200, the processing device 150 sets areas A1 and A2 at the sides of the fastening location 201 in the virtual surface 350 as shown in FIG. 20B. The positions of the areas A1 and A2 with respect to the fastening location 201 and the sizes of the areas A1 and A2 are preregistered. As illustrated by arrows a1 and a2 in the areas A1 and A2, the processing device 150 searches for a position of the virtual object 301 at which the virtual object 301 does not overlap the article 200 while changing the display position of the virtual object 301. When a position at which the article 200 is not overlapped is found, the processing device 150 sets the display position of the virtual object 301 to that position. When the virtual object 301 overlaps the article 200 at all points in the areas A1 and A2, the processing device 150 sets the display position of the virtual object 301 to the position at which the overlap amount is smallest.

The processing device 150 causes the position on the virtual surface 350 that is set to reflect the display position of the virtual object 301. The overlap amount between the virtual object and the real object is reduced thereby. For example, by performing the opposite processing of the processing shown in FIG. 17, the display position of the virtual object 301 is caused to reflect the position that is set. More specifically, the processing device 150 generates four straight lines connecting the display device 100 and the four corners of the virtual object 301 at the set position. The intersections between the four straight lines and the plane including the original positions P3a to P3d of the virtual object 301 are the positions of the four corners of the virtual object 301 after the modification.

For example, data that indicates whether the overlap with the virtual object is permitted or not permitted is preregistered for each article. For articles for which overlap with the virtual object is not permitted, the display position of the virtual object is set by searching for a display position at which the virtual object does not overlap the article as described above.

Information that indicates the range of the article is necessary to determine the overlap between the article and the virtual object. For example, the processing device 150 extracts surfaces among the surface information obtained by the spatial mapping for which the distances to the display device 100 are less than a threshold. This is because in a normal task, articles are positioned more proximate to the worker than the other platforms, walls, etc. The processing device 150 treats such surfaces as surfaces of articles. Tools and the like used in the task also may be treated as articles. As a result, the displayed virtual object does not easily overlap the tools; and the worker easily performs the task. The processing device 150 displays the virtual object not to overlap the extracted surfaces. Or, three-dimensional CAD data of the article on which the task is performed, the position of the article on which the task is performed, etc., may be preregistered. The processing device 150 displays the virtual object not to overlap the registered articles.

Embodiments are not limited to the examples described above; and the shape of the virtual surface 350, the shape and arrangement of the regions 351, the projection method onto the virtual surface 350, the search method of the position of the virtual object, etc., are modifiable as appropriate. For example, the virtual surface 350 may be curved instead of planar. A part of a circular columnar surface centered on the position of the display device 100 or a part of a spherical surface centered on the position of the display device 100 may be used as the virtual surface 350. The regions 351 may be triangular or hexagonal, and may be arranged in two directions that are not orthogonal to each other.

The timing of starting the display of the virtual object 301 is arbitrary. Favorably, the virtual object 301 is displayed after starting the task. The processing device 150 may estimate the start of the task. At least one of the following first to third estimation methods can be used to start the task.

In the first estimation method, an eye tracking function of the display device 100 is utilized. Generally, when starting the task, the worker pays attention to the location at which the task will be performed. When a screw will be fastened, the fastening location vicinity is paid attention while confirming the position of the fastening location, confirming the screw hole, placing the screw, etc.

The processing device 150 calculates the line of sight of the wearer by using eye tracking. The processing device 150 calculates the distances between the calculated line of sight and the preregistered positions of the fastening locations. When the shortest distance is less than a preset threshold, the processing device 150 determines that the worker is viewing the fastening location most proximate to the line of sight. When the shortest distance is less than the threshold continuously for more than a preset amount of time, the processing device 150 estimates that the worker has started the task at the fastening location viewed by the worker.

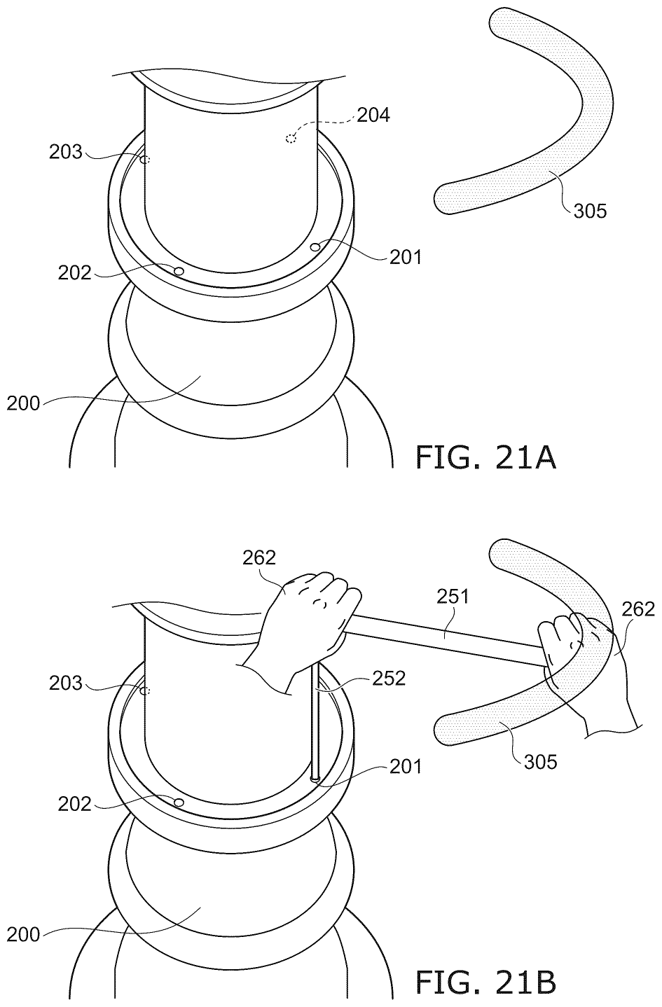

FIGS. 21A and 21B are schematic views for describing processing according to the first embodiment.

In the second estimation method, a virtual object for estimating the start of the task is displayed. For example, as shown in FIG. 21A, a virtual object 305 (a third virtual object) is displayed. The virtual object 305 is displayed in the area in which the hand may be when turning the screw at the fastening location 201. When the tool to be used is preregistered, the position and shape of the virtual object 305 are calculated based on the position of the fastening location 201 and the length of the tool.

When the task at the fastening location 201 is started, the right hand 262 approaches the virtual object 305 as shown in FIG. 21B. For example, the right hand 262 contacts the virtual object 305. The processing device 150 estimates that the task has been started when the distance between the virtual object 305 and one of the hands drops below a preset threshold.

The virtual object 305 may be displayed for each fastening location, or the virtual object 305 may be displayed for only one fastening location. For example, the sequence of the task for the fastening locations 201 to 204 is preregistered. The processing device 150 displays the virtual object 305 for one of the fastening locations 201 to 204 according to the sequence.

In the third estimation method, the movement of the hand is utilized. The hand that turns the tool moves in an arc-like shape while the tool is used to turn the screw. At this time, the position of the center of the rotation substantially does not change. For example, the position of the head of the wrench substantially does not change while the screw is being turned with the wrench. It can be estimated that the screw is being turned when the change of the position of the rotation center is small.

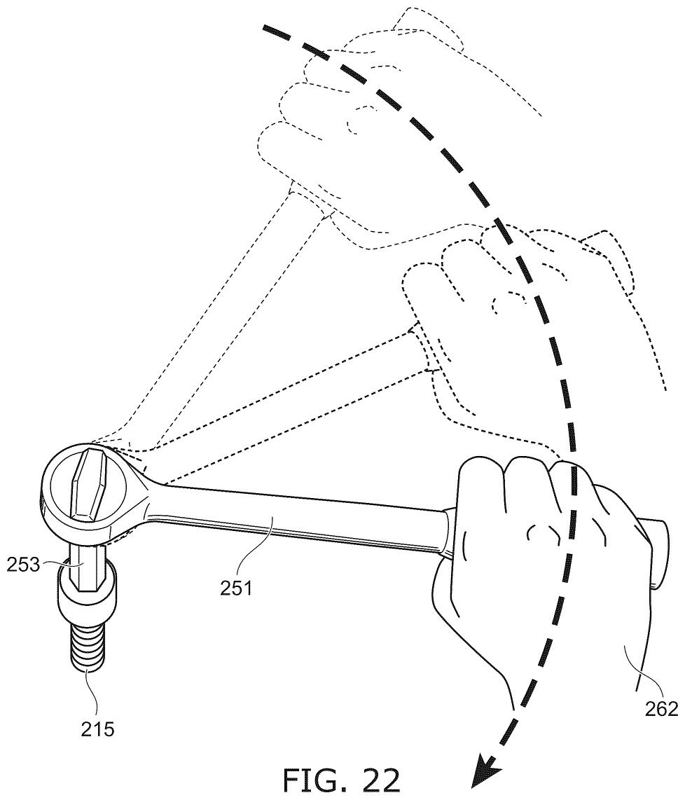

FIG. 22 is a schematic view showing a task.

For example, as shown in FIG. 22, the worker uses the wrench 251 to tighten a screw at a fastening location. Here, an example is described in which the extension bar 252 is not used. The worker places a screw 215 in a screw hole at a fastening location, which is not illustrated. The worker holds the grip of the wrench 251 with the right hand and causes the tip (the head) of the wrench 251 to which a socket is mounted to engage the screw 215. The worker turns the screw 215 by rotating the wrench 251.

The processing device 150 repeatedly measures the position of the hand while the worker turns the wrench 251. At this time, the hand is positioned on a circumference centered on a part of the wrench 251. The hand is moved to trace a circular arc. The processing device 150 utilizes this movement to calculate the center position of the rotation of the tool. The processing device 150 estimates the fastening location at which the screw is being turned based on the center position of the rotation. For example, the following first or second calculation method is used to calculate the center position.

FIGS. 23, 24A, 24B, 25, and 26 are schematic views for describing calculation methods according to the first embodiment.

In the first calculation method, the processing device 150 extracts three mutually-different positions from the multiple positions that are measured. The processing device 150 calculates a circumcenter O of the three positions. Here, as shown in FIG. 23, the three positions are taken as P₁(x₁, y₁, z₁), P₂(x₂, y₂, z₂), and P₃(x₃, y₃, z₃). The position of the circumcenter O is taken as P₀ (x₀, y₀, z₀). The length of the side opposite to the position P₁ of a triangle obtained by connecting the positions P₁ to P₃ to each other is taken as L₁. The length of the side opposite to the position P₂ is taken as L₂. The length of the side opposite to the position P₃ is taken as L₃. The angle at the position P₁ is taken as α. The angle at the position P₂ is taken as β. The angle at the position P₃ is taken as γ. In such a case, the position of the circumcenter O is represented by the following Formula (1). In Formula (1), the symbols marked with arrows represent position vectors. Formula (1) can be rewritten as Formula (2). Formula (2) can be broken down into Formulas (3) to (5).

$$\vec{{P}_{0}} = \frac{\begin{matrix}{L}_{1}^{2} ( {L}_{2}^{2} + {L}_{3}^{2} - {L}_{1}^{2} ) \vec{P 1} + {L}_{2}^{2} ( {L}_{3}^{2} + {L}_{1}^{2} - \\ {L}_{2}^{2} ) \vec{P 2} + {L}_{3}^{2} ( {L}_{1}^{2} + {L}_{2}^{2} - {L}_{3}^{2} ) \vec{P 3}\end{matrix}}{\begin{matrix}{L}_{1}^{2} ( {L}_{2}^{2} + {L}_{3}^{2} - {L}_{1}^{2} ) + {L}_{2}^{2} ( {L}_{3}^{2} + \\ {L}_{1}^{2} - {L}_{2}^{2} ) + {L}_{3}^{2} ( {L}_{1}^{2} + {L}_{2}^{2} - {L}_{3}^{2} )\end{matrix}} \qquad [ Formula 1 ]$$

$$( {x}_{0} , {y}_{0} , {z}_{0} ) = \frac{\begin{matrix}{L}_{1}^{2} ( {L}_{2}^{2} + {L}_{3}^{2} - {L}_{1}^{2} ) ( {x}_{1} , {y}_{1} , {z}_{1} ) + {L}_{2}^{2} ( {L}_{3}^{2} + {L}_{1}^{2} - \\ {L}_{2}^{2} ) ( {x}_{2} , {y}_{2} , {z}_{2} ) + {L}_{3}^{2} ( {L}_{1}^{2} + {L}_{2}^{2} - {L}_{3}^{2} ) ( {x}_{3} , {y}_{3} , {z}_{3} )\end{matrix}}{\begin{matrix}{L}_{1}^{2} ( {L}_{2}^{2} + {L}_{3}^{2} - {L}_{1}^{2} ) + {L}_{2}^{2} ( {L}_{3}^{2} + \\ {L}_{1}^{2} - {L}_{2}^{2} ) + {L}_{3}^{2} ( {L}_{1}^{2} + {L}_{2}^{2} - {L}_{3}^{2} )\end{matrix}} \qquad [ Formula 2 ]$$

$${x}_{0} = \frac{\begin{matrix}{L}_{1}^{2} ( {L}_{2}^{2} + {L}_{3}^{2} - {L}_{1}^{2} ) {x}_{1} + {L}_{2}^{2} ( {L}_{3}^{2} + {L}_{1}^{2} - \\ {L}_{2}^{2} ) {x}_{2} + {L}_{3}^{2} ( {L}_{1}^{2} + {L}_{2}^{2} - {L}_{3}^{2} ) {x}_{3}\end{matrix}}{\begin{matrix}{L}_{1}^{2} ( {L}_{2}^{2} + {L}_{3}^{2} - {L}_{1}^{2} ) + {L}_{2}^{2} ( {L}_{3}^{2} + \\ {L}_{1}^{2} - {L}_{2}^{2} ) + {L}_{3}^{2} ( {L}_{1}^{2} + {L}_{2}^{2} - {L}_{3}^{2} )\end{matrix}} \qquad [ Formula 3 ]$$

$${y}_{0} = \frac{\begin{matrix}{L}_{1}^{2} ( {L}_{2}^{2} + {L}_{3}^{2} - {L}_{1}^{2} ) {y}_{1} + {L}_{2}^{2} ( {L}_{3}^{2} + {L}_{1}^{2} - \\ {L}_{2}^{2} ) {y}_{2} + {L}_{3}^{2} ( {L}_{1}^{2} + {L}_{2}^{2} - {L}_{3}^{2} ) {y}_{3}\end{matrix}}{\begin{matrix}{L}_{1}^{2} ( {L}_{2}^{2} + {L}_{3}^{2} - {L}_{1}^{2} ) + {L}_{2}^{2} ( {L}_{3}^{2} + \\ {L}_{1}^{2} - {L}_{2}^{2} ) + {L}_{3}^{2} ( {L}_{1}^{2} + {L}_{2}^{2} - {L}_{3}^{2} )\end{matrix}} \qquad [ Formula 4 ]$$

$${z}_{0} = \frac{\begin{matrix}{L}_{1}^{2} ( {L}_{2}^{2} + {L}_{3}^{2} - {L}_{1}^{2} ) {z}_{1} + {L}_{2}^{2} ( {L}_{3}^{2} + {L}_{1}^{2} - \\ {L}_{2}^{2} ) {z}_{2} + {L}_{3}^{2} ( {L}_{1}^{2} + {L}_{2}^{2} - {L}_{3}^{2} ) {z}_{3}\end{matrix}}{\begin{matrix}{L}_{1}^{2} ( {L}_{2}^{2} + {L}_{3}^{2} - {L}_{1}^{2} ) + {L}_{2}^{2} ( {L}_{3}^{2} + \\ {L}_{1}^{2} - {L}_{2}^{2} ) + {L}_{3}^{2} ( {L}_{1}^{2} + {L}_{2}^{2} - {L}_{3}^{2} )\end{matrix}} \qquad [ Formula 5 ]$$

x₀, y₀, and z₀ are calculated respectively from Formulas (3) to (5). The processing device 150 calculates the position P₀(x₀, y₀, z₀) of the circumcenter O as the center position of the rotation of the wrench 251.

The center position of the rotation of the wrench 251 can be considered to be the position at which the screw 215 is being turned by the wrench 251. Then, it can be estimated that the screw is being tightened at the fastening location most proximate to the center position. The processing device 150 calculates the distances between the center position of the wrench 251 and the positions of the fastening locations. When one of the distances is less than a preset threshold, the processing device 150 assumes that the screw is being turned at that fastening location.

The processing device 150 repeats the extraction of a combination of three positions and the calculation of the center position. When the distance between the center position and the fastening location is continuously less than the threshold for a preset time or more, the processing device 150 estimates that the screw is being turned at the fastening location.

When a digital tool is used, the detection result of the tool may be used to estimate the task. For example, when the distance between each center position and the fastening location for a prescribed duration is less than the threshold and a torque value is detected by the tool, the processing device 150 estimates that the screw is being turned at the fastening location.

To more accurately estimate the position of the screw in the first calculation method described above, the length of the tool interposed between the wrench 251 and the screw may be used in the calculation. In the example shown in FIG. 22, a socket 253 engages the wrench 251. In other words, the center position of the rotation of the wrench 251 and the position of the screw are separated by the length of the socket 253. When the length of the socket 253 is preregistered, the processing device 150 can use the center position and the length of the socket 253 to more accurately estimate the position of the screw.

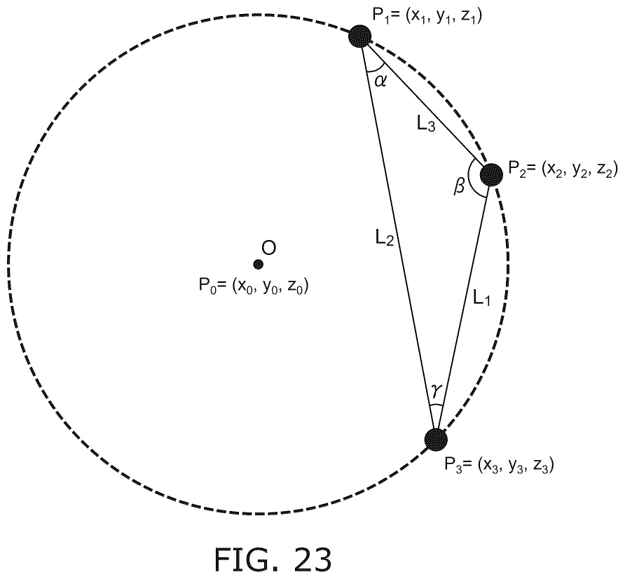

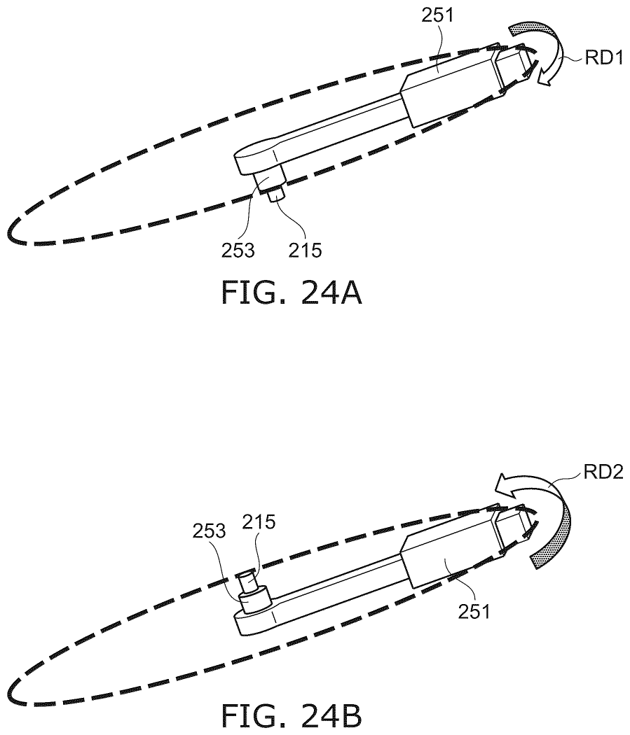

When using the length of the socket 253 to estimate the position of the screw, it is necessary to determine the side at which the screw is positioned with respect to the plane in which the wrench 251 is rotating. In the example shown in FIG. 24A, the wrench 251 rotates in a rotation direction RD1. The screw 215 and the socket 253 are positioned at the lower side. In the example shown in FIG. 24B, the wrench 251 rotates in a rotation direction RD2. The rotation direction RD2 is the opposite of the rotation direction RD1. The screw 215 and the socket 253 are positioned at the upper side of a plane parallel to the rotation direction RD2.

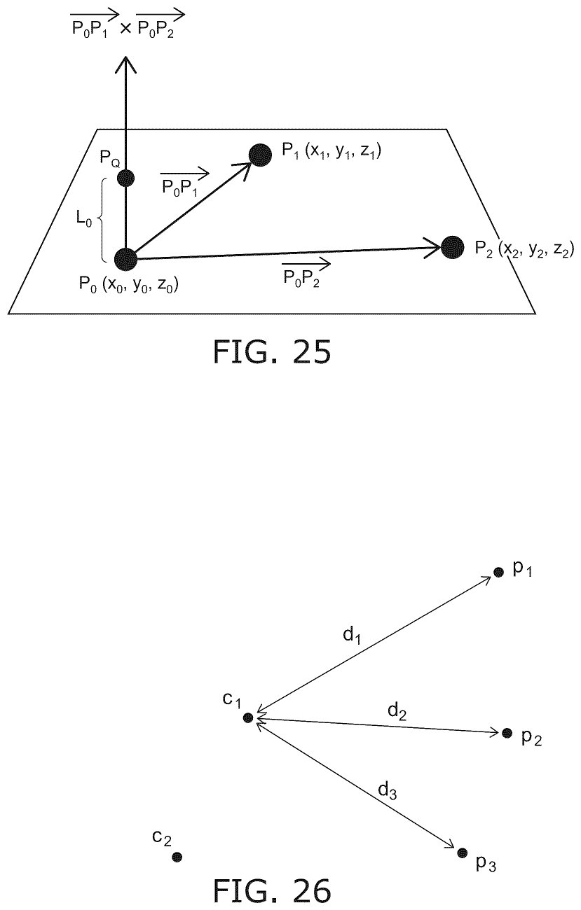

To determine the side at which the screw 215 is positioned, the processing device 150 uses the center position, two positions of the hand, time-series information of the two positions, and tighten/loosen information of the screw. For example, as shown in FIG. 25, the two positions are taken as P₁(x₁, y₁, z₁) and P₂(x₂, y₂, z₂). The center position is taken as P₀(x₀, y₀, z₀). The time at which the hand is at the position P₁ and the time at which the hand is at the position P₂ are known. In other words, the processing device 150 stores time-series information of the positions P₁ and P₂. In the example, the time at which the hand was positioned at the position P₁ is before the time at which the hand was positioned at the position P₂.

The tighten/loosen information indicates whether the screw is being tightened or loosened. When the wrench 251 is a digital tool, the wrench 251 generates the tighten/loosen information by determining whether the screw is being tightened or loosened based on the detected torque value. The processing device 150 may generate the tighten/loosen information by determining whether the screw is being tightened or loosened based on the time-series data of the torque value received from the wrench 251.

A plane that passes through the positions P₀ to P₂ is represented by the following Formula (6). In Formula (6), k, l, m, and n are constants.

$$kx + ly + mz + n = 0 \qquad [ Formula 6 ]$$

The following Formulas (7) to (9) are obtained by substituting the coordinates of P₀ to P₂ in Formula (6). The constants k, l, m, and n are calculated from Formulas (7) to (9).

$${kx}_{0} + {ly}_{0} + {mz}_{0} + n = 0 \qquad [ Formula 7 ]$$

$${kx}_{1} + {ly}_{1} + {mz}_{1} + n = 0 \qquad [ Formula 8 ]$$

$${kx}_{2} + {ly}_{2} + {mz}_{2} + n = 0 \qquad [ Formula 9 ]$$

Here, the processing device 150 calculates a vector from the center position P₀ to the position P₁ at the previous time. Also, the processing device 150 calculates a vector from the center position P₀ to the position P₂ at the subsequent time. The screw 215 is at a position P_{Q} that is separated from the center position P₀ by a length L₀ of the socket 253 on the normal vector P₀P₁×P₀P₂. When the screw is being tightened and the time of the position P₁ is before the time of the position P₂, the processing device 150 calculates the normal vector P₀P₁×P₀P₂ of the vector P₀P₁ and the vector P₀P₂.

The length from the position P₀ to the position P_{Q} at which the wrench and the socket act on the screw is represented by the following Formula (10). In the following formulas, the symbols marked with arrows indicate that the value of the symbol is a vector.

$$\vec{\vert {P}_{0} {P}_{Q} \vert} = √ \{ {( k - {x}_{0} )}^{2} + {( l - {y}_{0} )}^{2} + {( m - {z}_{0} )}^{2} \} = {L}_{0} \qquad [ Formula 10 ]$$

On the other hand, the vector from the position P₀ to the position P_{Q} also may be represented by the following Formula (11). In Formula (11), t is a constant.

$$\vec{{P}_{0} {P}_{Q}} = ( k - {x}_{0} , l - {y}_{0} , m - {z}_{0} ) = t ( k , l , m ) \qquad [ Formula 11 ]$$

The following Formula (12) is obtained by substituting Formula (11) in Formula (10). The length L₀ in Formula (12) is preregistered. t is calculated by solving Formula (12).

$$√ \{ ( {\{ ( {y}_{1} - {y}_{0} ) ( {z}_{2} - {z}_{0} ) - ( {y}_{2} - {y}_{0} ) ( {z}_{2} - {z}_{0} ) \}}^{2} * {t}^{2} + \{ ( {z}_{1} - {z}_{0} ) ( {x}_{2} - {x}_{0} ) - ( {z}_{2} - {z}_{0} ) ( {x}_{1} - {x}_{0} ) \} * {t}^{2} + \{ ( {x}_{1} - {x}_{0} ) ( {y}_{2} - {y}_{0} ) - ( {x}_{2} - {x}_{0} ) ( {y}_{1} - {y}_{0} ) \} * {t}^{2} \} = {L}_{0} \qquad [ Formula 12 ]$$

When t is calculated, the position P_{Q} is calculated using the position P₀ and the constants k, l, m, n, and t. In other words, the position of the screw is obtained.

The processing device 150 calculates the distance between the calculated position of the screw and the positions of the fastening locations. When one distance is less than a preset threshold, the processing device 150 assumes that the screw is being turned at that fastening location. The processing device 150 repeats the calculation of the position of the screw. When the distance between the position of the screw and the fastening location is less than the threshold for a prescribed duration, the processing device 150 estimates that the screw is being turned at the fastening location.

As shown in FIG. 6, there are cases where the screw is fastened via the extension bar 252. In such a case as well, similarly to the method described above, the position of the screw can be estimated using the length of the extension bar 252. In other words, the screw is at a position separated from the center position P₀ by the sum of the length of the extension bar 252 and the length of the socket 253 on the normal vector P₀P₁×P₀P₂. The position P_{Q} of the screw is estimated using the center position P₀, the length of the extension bar 252, and the length of the socket 253. The position of the screw can be estimated with higher accuracy by considering the length of another tool interposed between the screw and the wrench 251.

In the second calculation method, the center position of the rotation is preregistered for each fastening location. For example, as shown in FIG. 26, center positions c1 and c2 are preregistered for the fastening locations 201 and 202. Three positions p₁ to p₃ of the hand are calculated based on images of the hand turning the screw. The processing device 150 calculates distances d1 to d3 respectively between the center position c1 and the positions p1 to p3. Similarly, the processing device 150 calculates the distances respectively between the center position c₂ and the positions p1 to p3. The processing device 150 calculates the fluctuation of the distances respectively between the center position c₁ and the positions p1 to p3, and calculates the fluctuation of the distances respectively between the center position c₂ and the positions p1 to p3. When one of the fluctuations is less than a threshold, the processing device 150 estimates that the screw is being turned at the fastening location associated with that center position.

Examples of the fluctuation include an average value of multiple distances, a sum of differences between the distances, the variance of the multiple distances, the standard deviation of the multiple distances, etc. In the example shown in FIG. 26, the positions p1 to p3 of the hand are substantially equidistant from the center position c₁. It is therefore estimated that the screw is being turned at the fastening location 201 associated with the center position c₁.

For example, the processing device 150 repeats the first or second calculation method regardless of whether or not the task is being performed. Specifically, the processing device 150 uses multiple positions of the hand obtained in a prescribed duration to perform the first or second calculation method. When it is not estimated that the task is being performed based on the multiple positions of the hand in the duration, the processing device 150 slides the duration and re-performs the first or second calculation method. As an example, the duration is set to 6 seconds; and the slide amount is set to 16 milliseconds. The duration and the slide amount are appropriately set according to the performance of the processing device 150.

When the task is not being performed, the tool does not actually rotate, and there is no center of rotation. However, an apparent center position can be calculated based on multiple positions of the hand. While the task is not being performed, the calculated center position is separated from the positions of the fastening locations. It is therefore not estimated that the task is being performed. When the task is performed, the calculated center position approaches the position of the fastening location. The processing device 150 estimates the timing at which the task is initially estimated to be performed to be the start of the task.

When the start of the task is estimated using one of the first to third estimation methods described above, the processing device 150 displays the virtual object 301. The size of the virtual object 301 that includes information tends to be large. The large virtual object 301 tends to overlap the real object, and so it becomes difficult for the worker to view the real object. By displaying the virtual object 301 including the information after starting the task, the efficiency of the task can be increased.

According to the first or second estimation method, the start of the task can be estimated directly before the screw is actually turned. Therefore, the information related to the task can be displayed to the worker at the start of the task. On the other hand, in the first estimation method, the start of the task cannot be estimated when the fastening location is difficult to view due to its position. According to the second or third estimation method, the start of the task can be estimated even when the fastening location is difficult to view from the display device 100 due to its position.

Favorably, the processing device 150 stops displaying the virtual object when the end of the task is estimated after starting the task. The end of the task is estimated based on the detection result of the digital tool. For example, the processing device 150 estimates the end of the task at the timing at which the detected torque value reaches a preset torque value. Or, the processing device 150 estimates the end of the task when a state in which the torque value is not detected continues for more than a preset time.

According to the first to third estimation methods, the start of the task can be estimated, and the fastening location at which the screw is being turned can be estimated. For example, the processing device 150 may associate data indicating that the screw is tightened with data of the location at which it is estimated that the screw is being tightened. The task record can be automatically generated thereby.

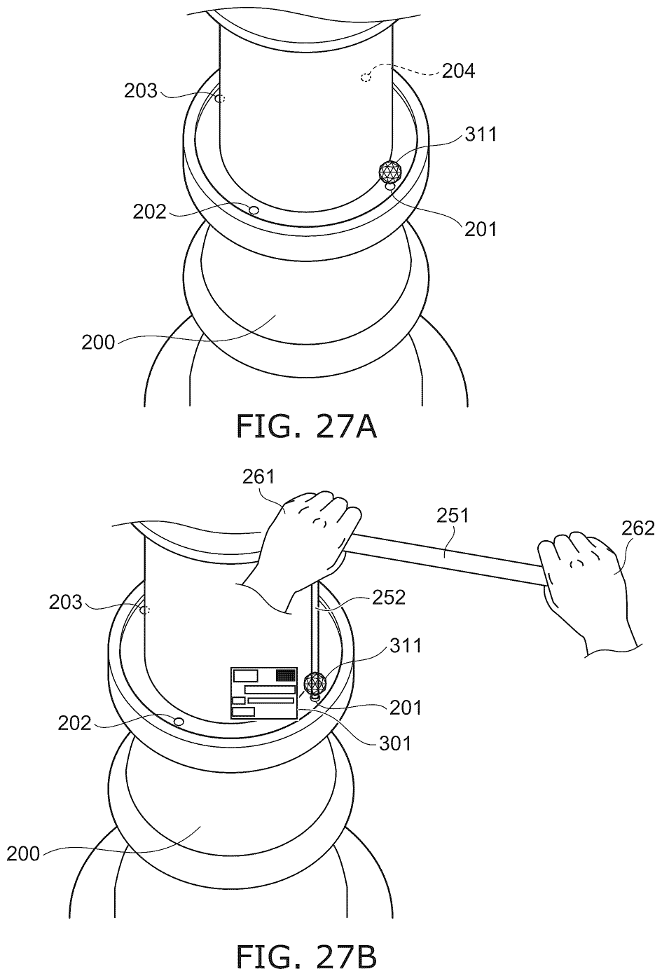

FIGS. 27A, 27B, 28A, 28B, 29A, and 29B are schematic views showing display examples according to the display device according to the first embodiment.

Other than the virtual object that includes the information, another virtual object may be displayed. For example, as shown in FIG. 27A, the processing device 150 displays a virtual object 311 (a second virtual object) proximate to the fastening location 201. The virtual object 311 may be displayed to overlap the fastening location 201. The virtual object 311 shows the worker that a screw is to be turned at the fastening location 201.

The processing device 150 estimates the start of the task when the screw is turned at the fastening location 201. As shown in FIG. 27B, the processing device 150 displays, at the side of the fastening location 201, the virtual object 301 including the information of the task at the fastening location 201. The virtual object 301 is positioned at the side of the virtual object 311. The distance between the fastening location 201 and the virtual object 311 is less than the distance between the fastening location 201 and the virtual object 301.

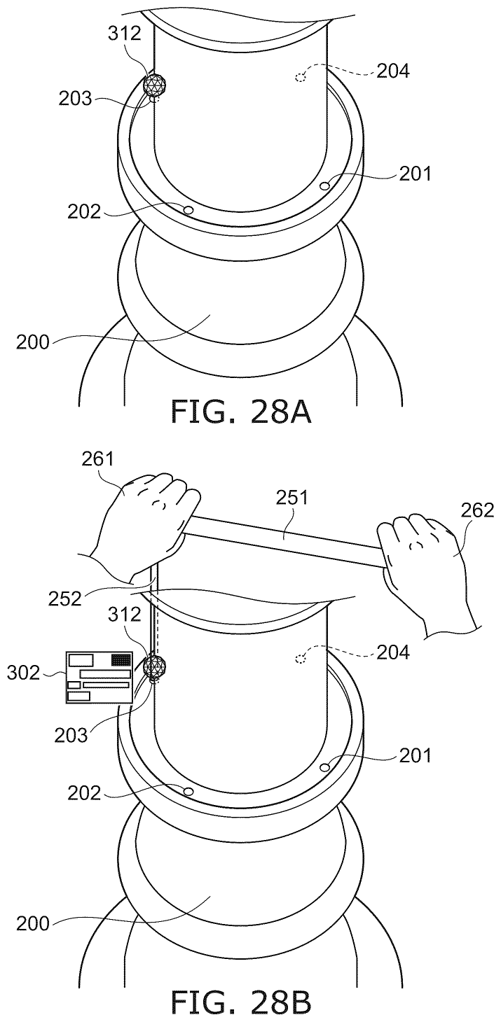

When the end of the task is estimated, the processing device 150 stops displaying the virtual objects 301 and 311. As shown in FIG. 28A, the processing device 150 displays a virtual object 312 at the fastening location 203. The virtual object 312 shows the worker that a screw is to be turned at the fastening location 203. The processing device 150 estimates the start of the task when the screw is turned at the fastening location 203. As shown in FIG. 28B, the processing device 150 displays, at the side of the fastening location 203, a virtual object 302 that includes the information of the task at the fastening location 203.

When the end of the task at the fastening location 203 is estimated, virtual objects are sequentially displayed at the vicinities of the fastening locations 202 and 204. The worker sequentially turns screws at the fastening locations 202 and 204 while referring to the virtual objects.

In the illustrated example, the virtual objects 311 and 312 are spherical and do not include characters. The sizes of the virtual objects 311 and 312 are less than the sizes of the virtual objects 301 and 302. The specific shapes of the virtual objects 311 and 312 are modifiable as appropriate.

For example, the sequence of the task at the fastening locations 201 to 204 is preregistered. The processing device 150 displays the spherical virtual objects at the fastening locations 201 to 204 according to the sequence.

When the sequence of the task at the multiple fastening locations is specified, the processing device 150 also can determine whether or not the fastening location of the task is appropriate. For example, the processing device 150 determines whether or not the fastening location at which it is estimated that the screw is being turned matches the fastening location at which the task should be performed. When the estimated fastening location does not match the fastening location at which the task should be performed, the processing device 150 determines that the screw is being turned at an erroneous fastening location.

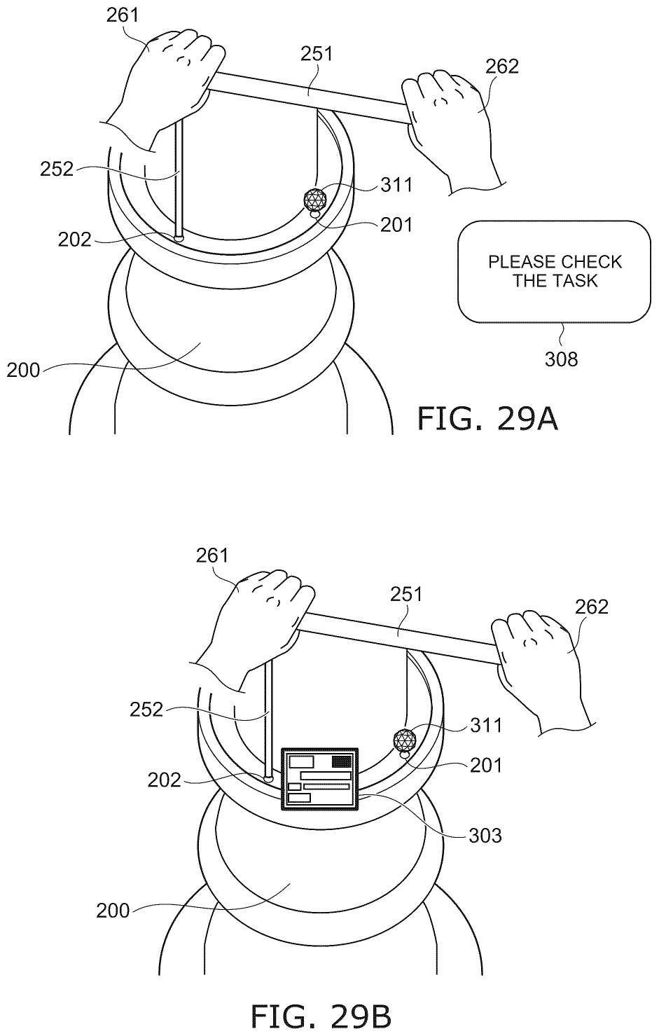

In such a case, the processing device 150 outputs an alert 308 as shown in FIG. 29A. In the illustrated example, a message is displayed toward the worker as an alert. Instead of a display, the processing device 150 may cause a prescribed output device to output a voice, a sound, a vibration, light, etc., as the alert.

Or, as shown in FIG. 29B, together with the alert, the processing device 150 may display a virtual object 303 that includes information related to the erroneous fastening location 202. The virtual object 303 is displayed at the side of the fastening location 202. In the illustrated example, the display form of the virtual object 303 is different from the display form of the virtual object 301 or the virtual object 302. Specifically, the thickness of the frame of the virtual object 303 is different from the thickness of the frame of the virtual object 301 or the virtual object 302. The periphery of the virtual object 303 is marked with a warning color. Other than the illustrated example, the size or color of the virtual object 303 may be different from the size or color of the virtual object 301 or 302.

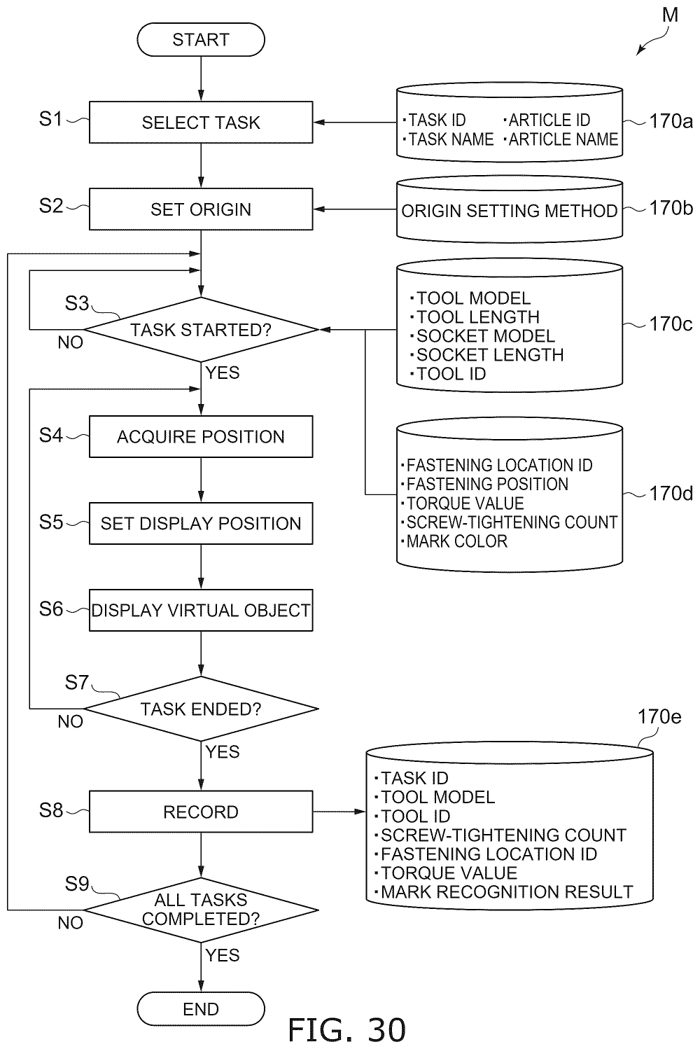

FIG. 30 is a flowchart showing a processing method according to the embodiment.

Before performing the processing method M shown in FIG. 30, task master data 170a, origin master data 170b, tool master data 170c, and fastening location master data 170d are prepared. Each set of master data is stored in the storage device 170.

First, the task to be performed is selected (step S1). The task ID, the task name, the article ID, and the article name are registered in the task master data 170a. The task is designated by the task ID, the task name, the ID of the article on which the task is performed, the name of the article, etc. The processing device 150 accepts the selection of the task. For example, the task to be performed is selected by the worker. The task to be performed may be selected by a higher-level system; and the processing device 150 may accept the selection. The processing device 150 may determine the task to be performed based on the data obtained from the image camera 131 or another sensor. The processing device 150 selects the task based on the determination result.

Then, the image camera 131 images the marker 210. The processing device 150 sets the origin of the three-dimensional coordinate system by using the position and orientation of the marker 210 as a reference (step S2). At this time, the processing device 150 refers to the origin master data 170b. The origin master data 170b stores the setting method of the origin for each task. The processing device 150 acquires the setting method of the origin for the selected task and sets the origin according to the setting method.

After setting the origin, the processing device 150 determines whether or not the task is started (step S3). The start of the task may be estimated by performing one of the first to third estimation methods described above. When the start of the task is estimated, the data of the tool master data 170c and the fastening location master data 170d is referred to as appropriate.

The tool master data 170c stores the ID of the tool to be used, the model of the tool, the length of the tool, the model of the socket, the length of the socket, etc., for each task. The model of the tool indicates the classification of the tool by structure, exterior shape, performance, etc. The length of the tool is the length from the rotation center to the grip when the tool is used for screw-tightening. The model of the socket indicates the classification of the socket by structure or exterior shape. The length of the socket refers to the length of the socket in the direction connecting the tool and the screw when tightening the screw. The processing device 150 acquires, from the tool master data 170c, the data of the tool to be used in the task selected in step S1. When an extension bar is used, the model, length, etc., of the extension bar also are stored in the tool master data 170c. The processing device 150 also acquires the data related to the extension bar from the tool master data 170c.

The ID of the fastening location, the position of the fastening location, the necessary torque value, and the screw-tightening count for each fastening location are stored in the fastening location master data 170d. The fastening position is the position at which the fastening location is present; and the coordinate of the three-dimensional coordinate system set in step S2 is registered. The screw-tightening count is the number of times that the screw must be tightened for each fastening location. When the screw is to be marked after fastening, the color of the mark also is registered.

The processing device 150 acquires the position of the display device 100 (step S4) when it is determined that the task has started in step S3. Spatial mapping or another positioning system is used to acquire the position. Based on the acquired position, the processing device 150 sets the display position of the virtual object at a prescribed position with respect to the fastening location when viewed from the display device 100 (step S5). The processing device 150 displays the virtual object including the information of the task at the set display position (step S6). As a result, for example, as shown in FIG. 4, the virtual object 301 is displayed at the side of the fastening location 201.

The processing device 150 determines whether or not the task has ended (step S7). Step S4 is re-performed when the task has not yet ended. By repeating steps S4 to S6, the display position of the virtual object is updated according to the movement of the display device 100 in the task.

When it is determined that the task has ended, the processing device 150 generates a record of the task at the fastening location at which it is estimated that the screw is being turned (step S8). The generated record is stored in history data 170e. For example, the torque value that is detected by the tool is associated with the ID of the task and the ID of the estimated location. As illustrated, the processing device 150 also may associate the model and ID of the tool used, the screw-tightening count, and the recognition result of the mark with the ID of the fastening location. The mark is recognized by the processing device 150 based on the image that is imaged by the image camera 131. The processing device 150 extracts an aggregate of pixels of the mark color from the image and counts the number of pixels in the aggregate. When the number of pixels is greater than a preset threshold, a mark is determined to be present.

The processing device 150 determines whether or not all of the tasks are completed (step S9). When not all of the tasks are completed, step S3 is re-performed. As a result, the start of the task is estimated at a fastening location at which the screw has not yet been turned.

### Modifications

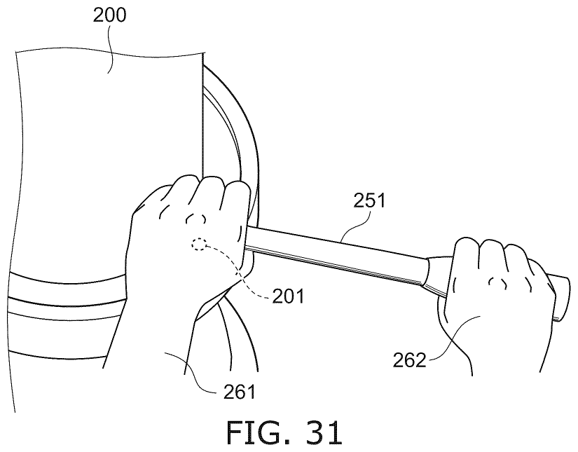

FIG. 31 is a schematic view illustrating a task.

An example is described above in which an extension bar is used to turn the screw. As shown in FIG. 31, there are also cases where the screw is turned without using an extension bar. In such a case, the virtual object overlaps the tool when the virtual object is displayed at the side of the fastening location. There is a possibility that it may be difficult to view the tool from the worker; and the efficiency of the task may be reduced.

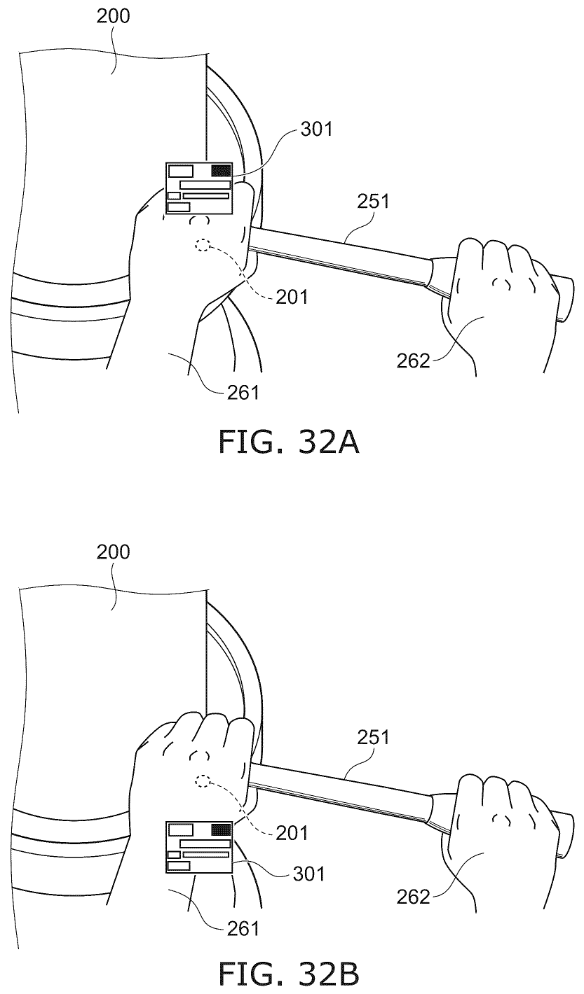

FIGS. 32A and 32B are schematic views showing display examples according to the display device according to a modification of the first embodiment.

In the example shown in FIG. 31, the worker uses the wrench 251 to turn the screw at the fastening location 201. In such a case, as shown in FIG. 32A, the processing device 150 displays the virtual object 301 above the fastening location 201. Or, as shown in FIG. 32B, the processing device 150 displays the virtual object 301 below the fastening location 201. As a result, the virtual object 301 does not easily overlap the tool.

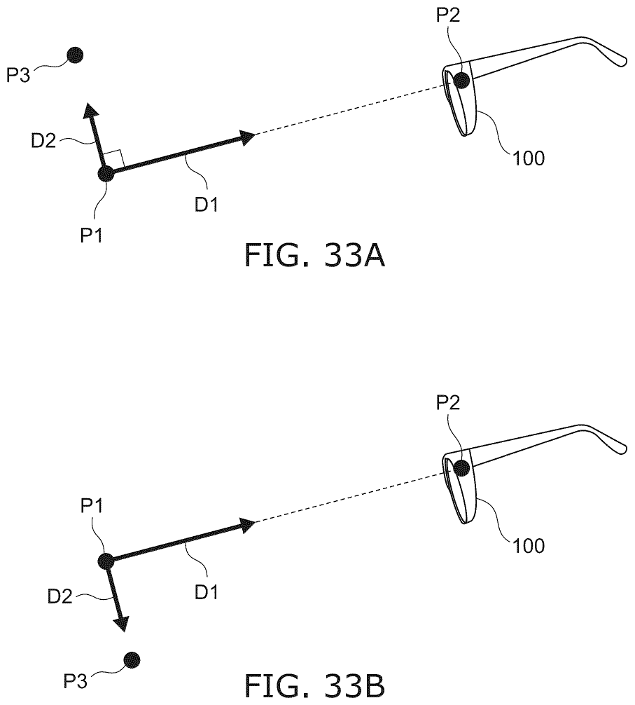

FIGS. 33A, 33B, 34A, 34B, and 35 are schematic views for describing processing according to the modification of the first embodiment.

The display position of the virtual object 301 is set based on the positional relationship between the display device 100 and the fastening location 201. For example, as shown in FIG. 33A, the processing device 150 calculates the direction D1 from the position P1 toward the position P2. The processing device 150 calculates the upward direction D2 that crosses the horizontal plane and is perpendicular to the direction D1. The processing device 150 calculates the position P3 to be separated from the position P1 by a prescribed distance in the direction D2.

When the virtual object 301 is displayed below the fastening location 201, the processing device 150 calculates the direction D1 from the position P1 toward the position P2 as shown in FIG. 33B. The processing device 150 calculates the downward direction D2 that crosses the horizontal plane and is perpendicular to the direction D1. The processing device 150 calculates the position P3 that is separated from the position P1 by a prescribed distance in the direction D2.

When the position P3 is calculated by one of the methods, the processing device 150 displays the virtual object 301 at the position P3. For example, the virtual object 301 is displayed to face from the position P3 toward the position P2 of the display device 100. The calculation of the position P3 is repeated at a prescribed interval. As a result, the display position of the virtual object is updated according to the movement of the display device 100.

When the display position of the virtual object 301 is fixed and the display device 100 moves upward from the state shown in FIG. 32A, the virtual object 301 may be displayed to overlap the fastening location 201. Similarly, when the display device 100 moves downward from the state shown in FIG. 32B, the virtual object 301 may be displayed to overlap the fastening location 201. By updating the display position of the virtual object 301 according to the movement of the display device 100, the time that the virtual object 301 overlaps the fastening location 201 can be reduced. By reducing the calculation interval of the display position, the virtual object 301 can be prevented from overlapping the fastening location 201.

After the display position of the virtual object 301 is set, the processing device 150 may determine whether or not the real object overlaps the virtual object 301. As shown in FIGS. 16 to 19B, the overlap of the real object and the virtual object can be determined by projecting the real object and the virtual object onto the virtual surface 350.

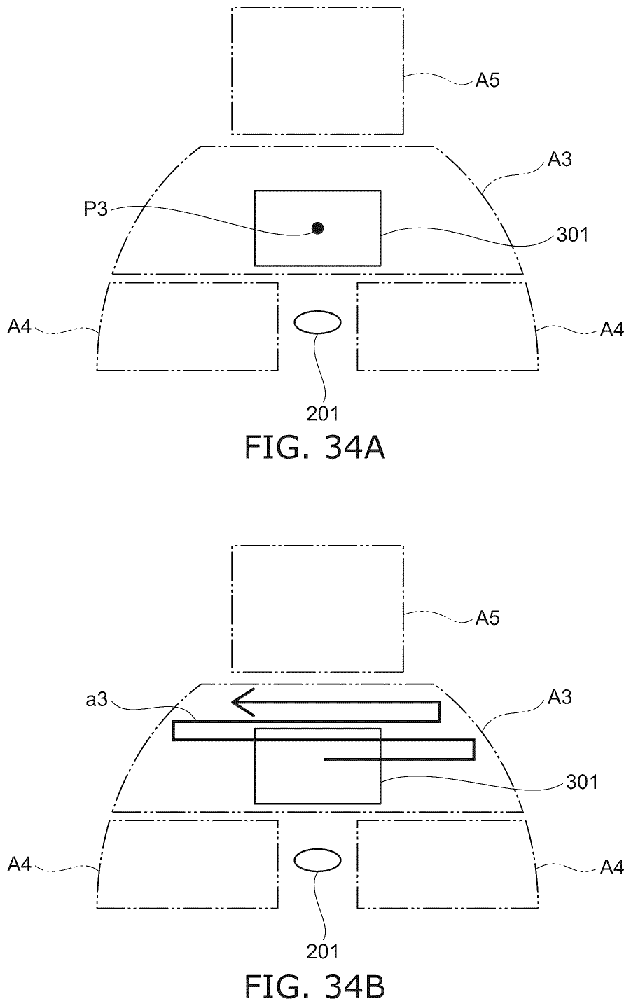

For example, as shown in FIG. 34A, the processing device 150 sets the areas A3 to A5 in the virtual surface 350 by using the position P3 as a reference. The number of areas to be set, the sizes of the areas, the positional relationship between the areas, etc., are preregistered. The area A3 includes the position P3. A pair of areas A4 is set at two sides of the fastening location 201. The area A5 is set at the side opposite to the pair of areas A4 with respect to the area A3. The area A3 is positioned between the area A5 and the pair of areas A4. When the virtual object 301 is displayed above the fastening location 201, the pair of areas A4 is positioned below the area A3; and the area A5 is positioned above the area A3.

The processing device 150 sequentially searches for the display position of the virtual object inside the area A3, the pair of areas A4, and the area A5. For example, as shown in FIG. 34B, as shown by arrow a3 in the area A3, the processing device 150 searches for a position at which the virtual objects do not overlap each other while modifying the position of the virtual object. When a position at which the virtual objects do not overlap each other is found in the area A3, the processing device 150 uses that position as the position of the virtual object after the modification.

When a position at which the virtual objects do not overlap each other cannot be found in the area A3, the processing device 150 searches for a position in the pair of areas A4. The search may be started in one of the pair of areas A4. When a position at which the virtual objects do not overlap each other is found in the area A4, the processing device 150 employs that position as the position of the virtual object after the modification. When a position at which the virtual objects do not overlap each other cannot be found in the areas A4, the processing device 150 searches for a position in the area A5. When a position at which the virtual objects do not overlap each other is found in the area A5, the processing device 150 employs that position as the position of the virtual object after the modification.

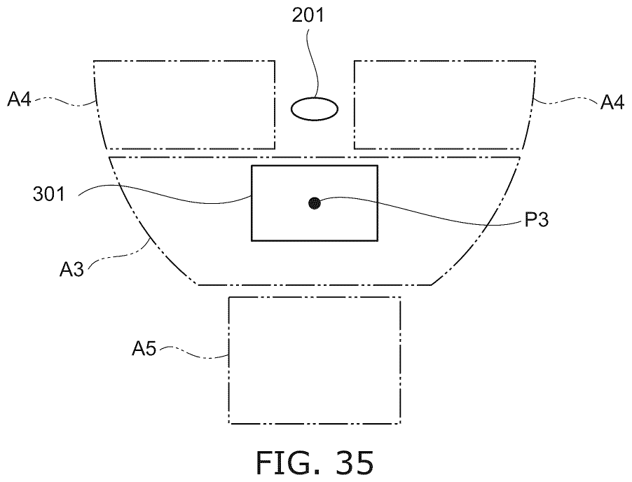

The display position of the virtual object 301 also is searched using a similar method when the virtual object 301 is displayed below the fastening location 201 and a real object overlaps the virtual object 301. As shown in FIG. 35, the pair of areas A4 is set above the area A3; and the area A5 is set below the area A3. The display position is sequentially searched inside the areas A3 to A5.

According to the modification, the overlap between the virtual object and the fastening location can be suppressed, and the convenience of the display device can be improved. By using the display device according to the modification, the efficiency of the task can be increased.

When the screw is tightened downward or upward, it is necessary to display the virtual object 301 to be separated from the fastening location 201 so that the virtual object 301 does not overlap a screw, a hand, a tool, etc. Therefore, when the virtual object 301 is displayed at the side of the fastening location 201, compared to when the virtual object 301 is displayed above or below the fastening location 201, the distance between the fastening location 201 and the virtual object 301 can be reduced. In other words, when the virtual object 301 is displayed to be arranged with the fastening location 201 in a direction crossing the screw hole direction of the fastening location 201, the worker easily confirms the information of the virtual object 301 while confirming the fastening location 201 or the screw.

It is common for an expert to pay attention to the head vicinity of the tool when performing the task. When the head vicinity is paid attention, it is desirable to display the virtual object 301 at a position that is shifted in the vertical direction with respect to a straight line connecting the position of the display device 100 (the eyes of the worker) and the head of the tool. As a result, the worker easily visually recognizes the information of the virtual object 301; and the virtual object 301 does not easily overlap the hand, the article (the fastening location), etc. For example, the display position in the vertical direction of the virtual object 301 with respect to the fastening location 201 is preset by considering the length of the screw. When the screw is tightened downward, the virtual object 301 is displayed to be slightly separated upward from the fastening location 201 so that the virtual object 301 is positioned above the head. When the screw is tightened upward, the virtual object 301 is displayed to be slightly separated downward from the fastening location 201 so that the virtual object 301 is positioned below the head.

A second embodiment of the invention will now be described. According to the first embodiment, the display position of the virtual object including the information is set at a prescribed position with respect to the fastening location when viewed from the display device. In contrast, according to the second embodiment, the display position of the virtual object is set above a hand recognized by the display device.

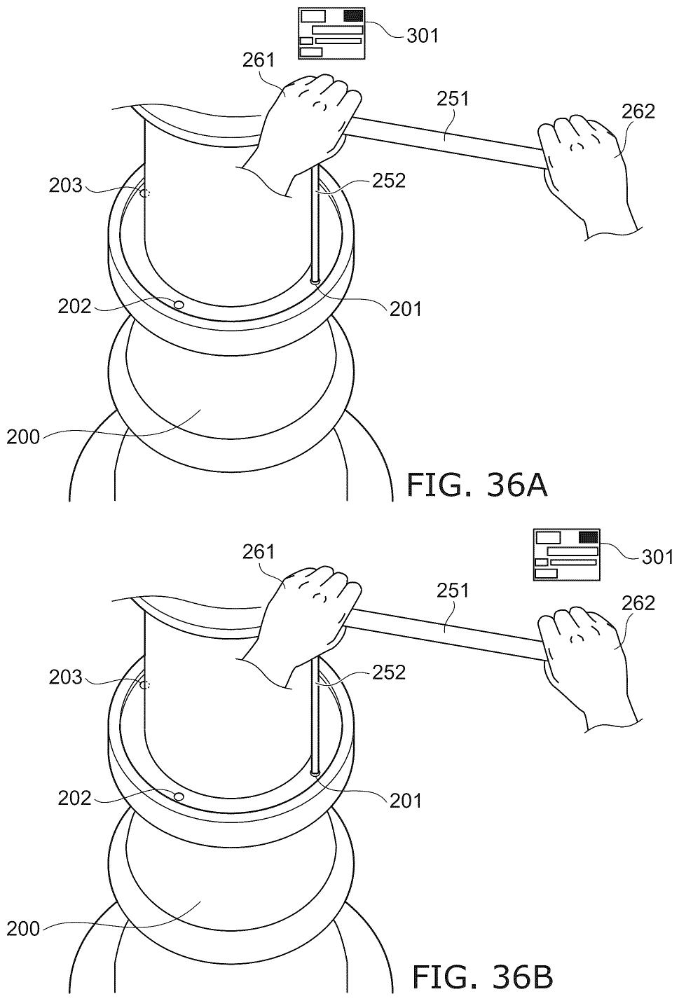

FIGS. 36A, 36B, 37A, 37B, and 38 are schematic views showing display examples according to the display device according to the second embodiment.

When an image of a hand is imaged, the processing device 150 recognizes the hand based on the image and measures the position of the hand. The processing device 150 displays the virtual object 301 above the hand. When the left hand 261 is recognized, the processing device 150 displays the virtual object 301 above the left hand 261 as shown in FIG. 36A. When the right hand 262 is recognized, the processing device 150 displays the virtual object 301 above the right hand 262 as shown in FIG. 36B. When both hands are recognized, the processing device 150 displays the virtual object 301 above one hand.

More favorably, the processing device 150 recognizes a hand that is moving a tool, and displays the virtual object 301 above that hand. The hand that is moving the tool is estimated by the third estimation method described for the estimation of the start of the task. According to the third estimation method, the start of the task is estimated; and the hand that is moving the tool is estimated. In the example shown in FIGS. 36A and 36B, it is estimated that the right hand 262 is moving the tool based on the trajectory of the right hand 262. The processing device 150 displays the virtual object 301 above the right hand 262.

The virtual object 301 is displayed at a position that is above the hand and is separated from the hand by a prescribed distance. The distance between the hand and the virtual object 301 is preset. Or, the distance may be set according to the recognition result of the joints of the hand. For example, the virtual object 301 is displayed at the position most proximate to the hand in an area in which the virtual object 301 does not overlap the hand.

It is common for the worker to view the hand that is moving the tool when performing the task. By displaying the virtual object 301 above the hand that is moving the tool, the worker easily confirms the information displayed in the virtual object 301. When the tool is being moved by both hands, the virtual object 301 may be displayed above one of the hands.

The processing device 150 repeats the recognition of the hand, the measurement of the position, and the setting of the display position of the virtual object 301. As a result, the display position of the virtual object 301 changes according to the movement of the hand.

By displaying the virtual object including the information above the hand, the virtual object does not easily overlap the article or the tool. The virtual object is easily viewed by the worker. Therefore, the worker easily confirms the information displayed in the virtual object.

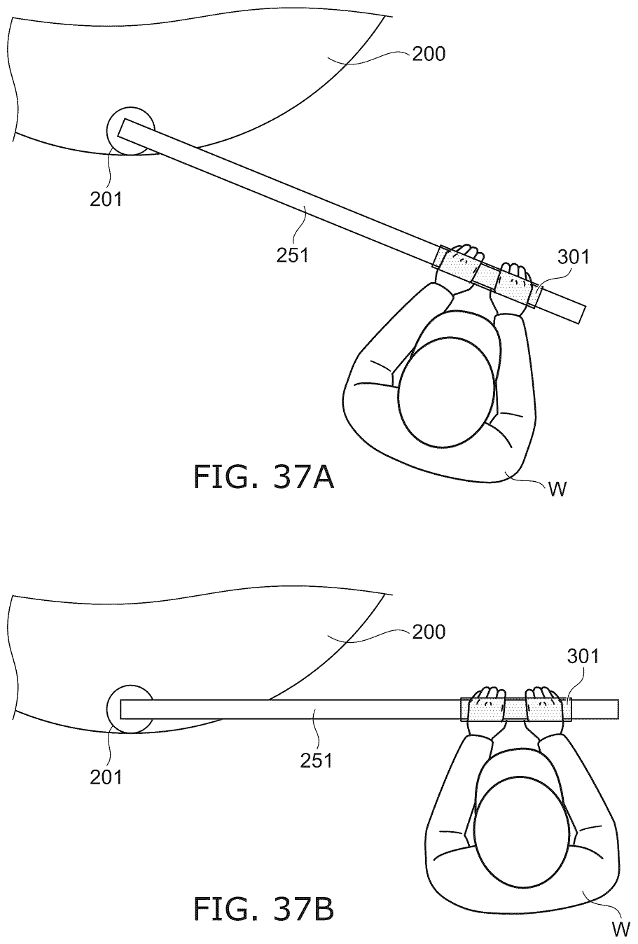

For example, as shown in FIG. 37A, a worker W holds a large wrench 251 with two hands. The worker W turns the screw at the fastening location 201 by moving the wrench 251 with two hands. The processing device 150 displays the virtual object 301 above one of the hands. When two hands are moved to move the wrench 251, the processing device 150 measures the positions of the hands after the movement. As shown in FIG. 37B, the processing device 150 displays the virtual object 301 above the hands after the movement.

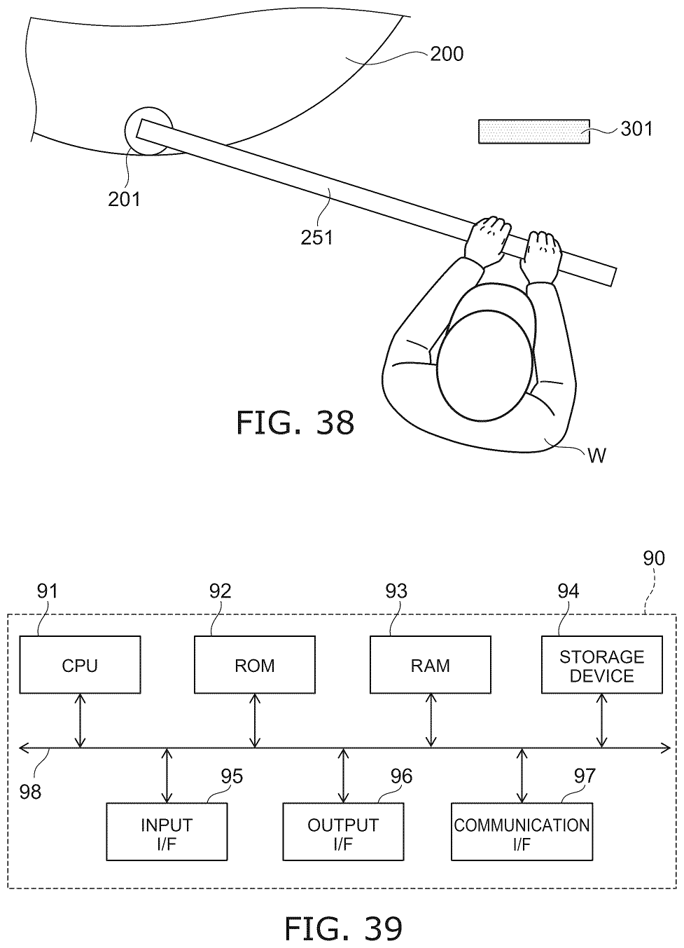

Subsequently, the worker W removes the wrench 251 once from the screw. The worker W causes the wrench 251 to re-engage the screw after moving the wrench 251 to the reverse orientation as before. At this time, the processing device 150 may display the virtual object 301 above the hands after the movement, or may fix the virtual object 301 at the position shown in FIG. 37B as shown in FIG. 38.

Specifically, the processing device 150 stores the position of the hands when the wrench 251 is turned most depthward. The processing device 150 displays the virtual object 301 to be fixed above the position. For example, the processing device 150 stores, as an initial position, the position of the hands at the timing at which the start of the task is estimated. The processing device 150 stores the position of the hands estimated to be turning the wrench 251 that is furthest from the initial position. The processing device 150 displays the virtual object 301 to be fixed above the most separated position.

Subsequently, if a position that is more distant to the initial position occurs, the virtual object 301 is displayed above the more separated position.

When the virtual object 301 is displayed above the hands, the virtual object 301 is displayed proximate to the face of the worker. Therefore, there is a possibility that it may be difficult for the worker to read the information of the virtual object 301. By fixing the display position of the virtual object 301 according to the position of the hands in the task, the worker easily reads the information of the virtual object 301.

According to the second embodiment, a display device is provided in which the convenience is further improved. By using the display device according to the second embodiment, the efficiency of the task can be increased.

The processing device 150 may determine whether to perform the first embodiment or second embodiment based on preregistered data. For example, data that indicates whether the first embodiment or the second embodiment is to be performed is preregistered for each task or article that is the task object. Or, the processing device 150 may determine whether to perform the second embodiment of the first embodiment based on data of the tool registered for each task.

When a large tool is used, the distance between the worker and the fastening location is longer. If the virtual object is displayed proximate to the fastening location, the virtual object is difficult to view from the worker. It is therefore favorable to display the virtual object above the hands by implementing the second embodiment. When a small or standard-sized tool is used, the virtual object is displayed proximate to the fastening location. The worker can perform the task while confirming both the fastening location and the virtual object.

For example, the display device 100 is an AR device that displays augmented reality (AR), or a MR device that displays mixed reality (MR). When the display device 100 is realized as a MR device, contact between a virtual object and a human body can be detected. Accordingly, it is favorable for the display device 100 to be a MR device when the second estimation method shown in FIGS. 21A and 21B is performed.

FIG. 39 is a schematic view showing a hardware configuration.

For example, a computer 90 shown in FIG. 39 is used as the processing device 150. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory and executes the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes a solid state drive (SSD), etc. The storage device 94 may be used as the storage device 170.

The input interface (I/F) 95 can connect the computer 90 with an input device. The CPU 91 can read various data from the input device via the input I/F 95.

The output interface (I/F) 96 can connect the computer 90 and an output device. The CPU 91 can output data to the output device via the output I/F 96.

The communication interface (I/F) 97 can connect the computer 90 and a device outside the computer 90. For example, the communication I/F 97 connects a digital tool and the computer 90 by Bluetooth (registered trademark) communication.

The data processing according to the processing device 150 may be performed by only one computer 90. A part of the data processing may be performed by a server or the like via the communication I/F 97.

Processing of various types of data described above may be recorded, as a program that can be executed by a computer, on a magnetic disk (examples of which include a flexible disk and a hard disk), an optical disk (examples of which include a CD-ROM, a CD-R, a CD-RW, a DVD-ROM, a DVD+R, and DVD+RW), a semiconductor memory, or another non-transitory computer-readable storage medium.

For example, information recorded on a recording medium can be read by a computer (or an embedded system). The recording medium can have any record format (storage format). For example, the computer reads a program from the recording medium and causes the CPU to execute instructions described in the program, on the basis of the program. The computer may obtain (or read) the program through a network.

Embodiments of the invention include the following features.

### Feature 1

A display device, configured to:
display a virtual space to overlap a real space;
acquire a position of a fastening location of an article present in the real space, the position of the fastening location being preregistered;
acquire a position of the display device;
set a display position of a first virtual object at a prescribed position with respect to the fastening location when viewed from the display device, the first virtual object including information related to the fastening location; and
repeat the acquisition of the position of the display device and the setting of the display position of the first virtual object.

### Feature 2

The display device according to feature 1, in which
the display position of the first virtual object is set at a side of the fastening location.

### Feature 3

The display device according to feature 1 or 2, further configured to:
determine whether or not an object present in the real space overlaps the first virtual object displayed at the display position; and
when the object overlaps the first virtual object, set the display position of the first virtual object to reduce an overlap amount between the object and the first virtual object.

### Feature 4

The display device according to feature 3, further configured to:
set a virtual surface in front of the object and the first virtual object; and
determine whether or not the object overlaps the first virtual object by projecting the object and the first virtual object onto the virtual surface.

### Feature 5

A display device, configured to:
display a virtual space to overlap a real space;
recognize a hand based on an image;
acquire information related to a fastening location of an article present in the real space; and
set a display position of a first virtual object above the hand, the first virtual object including the information.

### Feature 6

The display device according to feature 5, further configured to:
repeat the recognition of the hand and the setting of the display position of the first virtual object.

### Feature 7

The display device according to any one of features 1 to 6, in which
the information includes at least one selected from:
   a specified torque value necessary for a screw-tightening at the fastening location;
   a torque value detected by a tool used in the screw-tightening; or
   a screw-tightening count at the fastening location.

### Feature 8

The display device according to any one of features 1 to 7, further configured to:
set a three-dimensional coordinate system of the virtual space with a marker located in the real space as an origin;
preregister the position of the fastening location in the three-dimensional coordinate system; and
display a second virtual object at the fastening location, the second virtual object being different from the first virtual object.

### Feature 9

The display device according to any one of features 1 to 8, further configured to:
estimate a start of a task at the fastening location; and
display the first virtual object when the start of the task is estimated.

### Feature 10

The display device according to feature 9, in which
the start of the task is estimated using at least one selected from:
   a line of sight of a wearer;
   contact between a hand and a third virtual object displayed in a surrounding area of the fastening location; or
   a center position of a rotation of a tool calculated based on positions of a plurality of hands.

### Feature 11

A display control method of a display device, the display device being configured to display a virtual space to overlap a real space, the method including:
causing the display device to
   acquire a position of a fastening location of an article present in the real space, the position of the fastening location being preregistered,
   acquire a position of the display device,
   set a display position of a first virtual object at a prescribed position with respect to the fastening location when viewed from the display device, the first virtual object including information related to the fastening location, and
   repeat the acquisition of the position of the display device and the setting of the display position of the first virtual object.

### Feature 12

A display control method of a display device, the display device being configured to display a virtual space to overlap a real space, the method including:
causing the display device to
   recognize a hand based on an image,
   acquire information related to a fastening location of an article present in the real space, and
   set a display position of a first virtual object above the hand, the first virtual object including the information.

### Feature 13

A program, when executed by the display device according to feature 11 or 12, causing the display device to perform the display control method according to feature 11 or 12.

### Feature 14

A non-transitory computer-readable storage medium configured to store the program according to feature 13.

According to the embodiments above, a display device is provided in which the convenience is further improved. Or, a display control method, a program, and a storage medium are provided in which the convenience of the display device can be improved.

In the specification, “or” shows that “at least one” of items listed in the sentence can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A display device, configured to:
display a virtual space to overlap a real space;
acquire a position of a fastening location of an article present in the real space, the position of the fastening location being preregistered;
acquire a position of the display device;
set a display position of a first virtual object at a prescribed position with respect to the fastening location when viewed from the display device, the first virtual object including information related to the fastening location; and
repeat the acquisition of the position of the display device and the setting of the display position of the first virtual object.

2. The display device according to claim 1, wherein
the display position of the first virtual object is set at a side of the fastening location.

3. The display device according to claim 1, further configured to:
determine whether or not an object present in the real space overlaps the first virtual object displayed at the display position; and
when the object overlaps the first virtual object, set the display position of the first virtual object to reduce an overlap amount between the object and the first virtual object.

4. The display device according to claim 3, further configured to:
set a virtual surface in front of the object and the first virtual object; and
determine whether or not the object overlaps the first virtual object by projecting the object and the first virtual object onto the virtual surface.

5. A display device, configured to:
display a virtual space to overlap a real space;
recognize a hand based on an image;
acquire information related to a fastening location of an article present in the real space; and
set a display position of a first virtual object above the hand, the first virtual object including the information.

6. The display device according to claim 5, further configured to:
repeat the recognition of the hand and the setting of the display position of the first virtual object.

7. The display device according to claim 1, wherein
the information includes at least one selected from:
a specified torque value necessary for a screw-tightening at the fastening location;
a torque value detected by a tool used in the screw-tightening; or
a screw-tightening count at the fastening location.

8. The display device according to claim 1, further configured to:
set a three-dimensional coordinate system of the virtual space with a marker located in the real space as an origin;
preregister the position of the fastening location in the three-dimensional coordinate system; and
display a second virtual object at the fastening location, the second virtual object being different from the first virtual object.

9. The display device according to claim 1, further configured to:
estimate a start of a task at the fastening location; and
display the first virtual object when the start of the task is estimated.

10. The display device according to claim 9, wherein
the start of the task is estimated using at least one selected from:
a line of sight of a wearer;
contact between a hand and a third virtual object displayed in a surrounding area of the fastening location; or
a center position of a rotation of a tool calculated based on positions of a plurality of hands.

11. A display control method of a display device, the display device being configured to display a virtual space to overlap a real space, the method comprising:
causing the display device to
acquire a position of a fastening location of an article present in the real space, the position of the fastening location being preregistered,
acquire a position of the display device,
set a display position of a first virtual object at a prescribed position with respect to the fastening location when viewed from the display device, the first virtual object including information related to the fastening location, and
repeat the acquisition of the position of the display device and the setting of the display position of the first virtual object.

12. A display control method of a display device, the display device being configured to display a virtual space to overlap a real space, the method comprising:
causing the display device to
recognize a hand based on an image,
acquire information related to a fastening location of an article present in the real space, and
set a display position of a first virtual object above the hand, the first virtual object including the information.

13. A non-transitory computer-readable storage medium configured to store a program,
the program, when executed by the display device according to claim 11, causing the display device to perform the display control method according to claim 11.

14. A non-transitory computer-readable storage medium configured to store a program,
the program, when executed by the display device according to claim 12, causing the display device to perform the display control method according to claim 12.
